(19) United States
(12) Patent Application Publication
(10) Pub. No.: US 2026/0200179 A1
(43) Pub. Date: Jul. 16, 2026

(54) THREE-DIMENSIONAL FABRICATION APPARATUS AND THREE-DIMENSIONAL FABRICATION SYSTEM

(71) Applicant: Keyence Corporation, Osaka (JP)

(72) Inventors: Hiroki SAWANISHI, Osaka (JP); Shun IMAI, Osaka (JP); Tatsuya KITAGAWA, Osaka (JP)

(73) Assignee: Keyence Corporation, Osaka (JP)

(21) Appl. No.: 19/409,869

(22) Filed: Dec. 5, 2025

(30) Foreign Application Priority Data
Jan. 14, 2025 (JP) 2025-004856

(51) Int. Cl. B29C 64/393; B29C 64/118; B29C 64/182; B29C 64/209; B29C 64/336; B29C 64/40; B33Y 30/00; B33Y 40/00; B33Y 50/02

(52) U.S. Cl. CPC B29C 64/393; B29C 64/118; B29C 64/182; B29C 64/209; B29C 64/336; B29C 64/40; B33Y 30/00; B33Y 40/00; B33Y 50/02

(57) ABSTRACT

A fused filament fabrication type three-dimensional fabrication apparatus includes a first head unit to which a first hot end is fixed, a second head unit to which a second hot end including a second nozzle outlet having a diameter larger than that of the first nozzle outlet of the first hot end is fixed, and a control section that controls the first head unit so that a surface portion of a three-dimensional fabrication object is fabricated by a first filament ejected from the first hot end, and controls the second head unit so that an inner portion of the three-dimensional fabrication object is fabricated by a second filament ejected from the second hot end on the basis of fabrication data allocated to each of the first hot end and the second hot end.

### CROSS-REFERENCE TO RELATED APPLICATIONS

The present application claims foreign priority based on Japanese Patent Application No. 2025-004856, filed January 14, 2025, the contents of which are incorporated herein by reference.

### BACKGROUND OF THE INVENTION

### Technical Field

The present disclosure relates to a three-dimensional fabrication apparatus and a three-dimensional fabrication system including the three-dimensional fabrication apparatus.

### Description of Related Art

Conventionally, a so-called fused filament fabrication type three-dimensional fabrication apparatus, which extrudes a fused filament (resin for fabrication) to a fabrication plate and stacks the extruded filament to fabricate a three-dimensional fabrication object, is known.

As an example, JP2020-529346A discloses a fused filament fabrication type 3D printer. This 3D printer uses different types of nozzles depending on a three-dimensional basis to be formed.

According to JP2020-529346A described above, a higher fabrication speed can be realized by using a nozzle having a relatively large extrusion diameter (nozzle diameter).

However, when the nozzle diameter is increased, a high fabrication speed can be realized, but the stacking pitch of the filaments becomes coarse.

When the stacking pitch becomes coarse, the aesthetics of the three-dimensional fabrication object may be impaired. On the other hand, when the nozzle diameter is reduced, the aesthetics of the three-dimensional fabrication object is secured, but the fabrication time may become longer as the stacking pitch becomes finer.

### SUMMARY OF THE INVENTION

The present disclosure has been made in view of such a point, and an object thereof is to achieve both aesthetics and fabrication time of a three-dimensional fabrication object in a fused filament fabrication type three-dimensional fabrication apparatus.

One embodiment of the present disclosure relates to a three-dimensional fabrication apparatus configured to fabricate a three-dimensional fabrication object by extruding a fused filament to a fabrication plate that lowers in stages.

According to one embodiment described above, the three-dimensional fabrication apparatus includes: a supply part configured to supply the filament before being fused; a first extrusion part configured to draw in the filament supplied from the supply part and extrudes the filament downward; a first nozzle member configured to fuse the filament extruded by the first extrusion part and eject the fused filament to the fabrication plate; a first head unit to which the first extrusion part and the first nozzle member are fixed and configured to be movable along a direction in which the fabrication plate spreads; a second extrusion part configured to draw in the filament supplied from the supply part and extrude the filament downward; a second nozzle member configured to fuse the filament extruded by the second extrusion part and eject the fused filament to the fabrication plate, the second nozzle member including a nozzle outlet having a larger diameter than a nozzle outlet of the first nozzle member; a second head unit to which the second extrusion part and the second nozzle member are fixed and configured to be movable along the direction in which the fabrication plate spreads; a storage part configured to store fabrication data for fabricating the three-dimensional fabrication object, the fabrication data including a trajectory assigned to each of the first nozzle member and the second nozzle member; and a control part configured to, on a basis of the fabrication data stored in the storage part, control the first head unit so that a surface portion of the three-dimensional fabrication object is fabricated by the fused filament ejected from the first nozzle member, and control the second head unit so that an inner portion of the three-dimensional fabrication object is fabricated by the fused filament ejected from the second nozzle member.

According to one embodiment described above, the nozzle outlet from which a resin for fabricating the surface portion is ejected has a smaller diameter than the nozzle outlet from which a resin for fabricating the inner portion is ejected. In this way, the inner portion is fabricated at a coarser stacking pitch than an outer peripheral portion, and thus, the fabrication speed is excellent. On the other hand, since the surface portion is fabricated at a finer stacking pitch than the inner portion, the surface portion is excellent in aesthetics. Therefore, both the aesthetics and the fabrication time of the three-dimensional fabrication object can be achieved by performing the fabrication in which the two nozzle outlets are combined.

Furthermore, according to one embodiment of the present disclosure, a three-dimensional fabrication system including the three-dimensional fabrication apparatus may include: a mode selection section configured to select any one fabrication mode from among a speed fabrication mode in which the first head unit and the second head unit are controlled such that the surface portion of the three-dimensional fabrication object is fabricated by the fused filament ejected from the first nozzle member and the inner portion of the three-dimensional fabrication object is fabricated by the fused filament ejected from the second nozzle member, and one or a plurality of other fabrication modes in which operations of the first nozzle member and the second nozzle member are made different from operations in the speed fabrication mode; a fabrication data creation section configured to create the fabrication data on the basis of the fabrication mode selected by the mode selection section; and an output section configured to output the fabrication data to the three-dimensional fabrication apparatus so as to operate the first nozzle member and the second nozzle member in accordance with the fabrication data created by the fabrication data creation section.

According to one embodiment described above, a user can freely set the necessity of the speed fabrication mode. This can improve user convenience.

Furthermore, according to another embodiment of the present disclosure, the three-dimensional fabrication system may include an allocation change section configured to change allocation of the fabrication data to each of the first nozzle member and the second nozzle member on the basis of a user input.

According to another embodiment described above, the user can change the allocation of the fabrication data to each of the first nozzle member and the second nozzle member. This can improve user convenience.

Furthermore, according to still another embodiment of the present disclosure, the one or the plurality of other fabrication modes may include a support addition mode in which the first head unit and the second head unit are controlled such that a model portion of the three-dimensional fabrication object is fabricated by the fused filament ejected from one of the first nozzle member and the second nozzle member, and a support portion of the three-dimensional fabrication object is fabricated by another fused filament ejected from another of the first nozzle member and the second nozzle member.

According to still another embodiment described above, the three-dimensional fabrication apparatus can provide a fabrication mode using both the first nozzle member and the second nozzle member in addition to the speed fabrication mode. Since the number of options of the user increases, user convenience can be improved.

Furthermore, according to another embodiment of the present disclosure, the control part may selectively execute stacking of a first filament layer including the fused filament ejected from the first nozzle member and stacking of a second filament layer including the fused filament ejected from the second nozzle member, and after the first filament layer or the second filament layer is stacked, the control part may operate one head unit to which one extrusion part used for the stacking of the first filament layer or the second filament layer among the first extrusion part and the second extrusion part is fixed so as to move along the first filament layer or the second filament layer, operate the one head unit so as to reach a predetermined retraction position after the one head unit is turned back and moved along the first filament layer or the second filament layer, and start new stacking of the first filament layer or the second filament layer after the one head unit reaches the retraction position.

According to another embodiment described above, a resin leaking from the nozzle outlet after the stacking of the first or second filament layer can be applied to the first or second filament layer immediately after the stacking without accumulating the resin at a specific location. Thus, the aesthetics of the three-dimensional fabrication object can be enhanced.

Furthermore, according to still another embodiment of the present disclosure, the first extrusion part and the second extrusion part may be operable to pull in and pull back the filament upward, and the control part may execute movement of the one head unit along the first filament layer or the second filament layer and return movement of the one head unit along the first filament layer or the second filament layer while pulling back the filament by the one extrusion part.

According to still another embodiment described above, it is possible to more reliably execute application of the resin to the first or second filament layer immediately after the stacking. Thus, the aesthetics of the three-dimensional fabrication object can be enhanced.

As described above, according to the present disclosure, it is possible to achieve both the aesthetics and the fabrication time of the three-dimensional fabrication object in the fused filament fabrication type three-dimensional fabrication apparatus.

### BRIEF DESCRIPTION OF THE DRAWINGS

FIG. 1 is a diagram illustrating an overall configuration of a three-dimensional fabrication system;

FIG. 2 is a schematic diagram illustrating an internal structure of a three-dimensional fabrication apparatus;

FIG. 3 is a functional block diagram illustrating a schematic configuration of the three-dimensional fabrication apparatus;

FIG. 4 is a functional block diagram illustrating a schematic configuration of a fabrication data creation apparatus;

FIG. 5 is a diagram illustrating a display screen of the fabrication data creation apparatus;

FIG. 6 is a flowchart illustrating a creation procedure of fabrication data;

FIG. 7 is a flowchart illustrating a creation procedure of fabrication data;

FIG. 8 is a flowchart illustrating a creation procedure of fabrication data;

FIG. 9A is a diagram for describing a plurality of fabrication modes;

FIG. 9B is a diagram for describing a plurality of fabrication modes;

FIG. 10 is a diagram for describing selection of a fabrication mode;

FIG. 11 is a diagram for describing configuration information data;

FIG. 12 is a diagram for describing limitations on the types of selectable filaments;

FIG. 13 is a diagram for describing fabrication parameters;

FIG. 14A is a diagram for describing the fabrication parameters;

FIG. 14B is a diagram for describing the fabrication parameters;

FIG. 15 is a diagram illustrating a dialog for manually inputting the fabrication parameters;

FIG. 16 is a diagram illustrating a confirmation screen related to a collation result of the configuration information;

FIG. 17 is a flowchart illustrating a creation procedure of fabrication data;

FIG. 18 is a diagram for describing each path constituting fabrication data;

FIG. 19 is a flowchart illustrating a fabrication procedure of a three-dimensional fabrication object;

FIG. 20 is a flowchart illustrating a fabrication procedure in a speed fabrication mode;

FIG. 21 is a flowchart illustrating coating processing;

FIG. 22 is a diagram for describing the coating processing; and

FIG. 23 is a diagram illustrating an allocation change screen.

### DETAILED DESCRIPTION

Hereinafter, embodiments of the present disclosure will be described with reference to the drawings. Note that the following description is an example.

### 1. Overall configuration

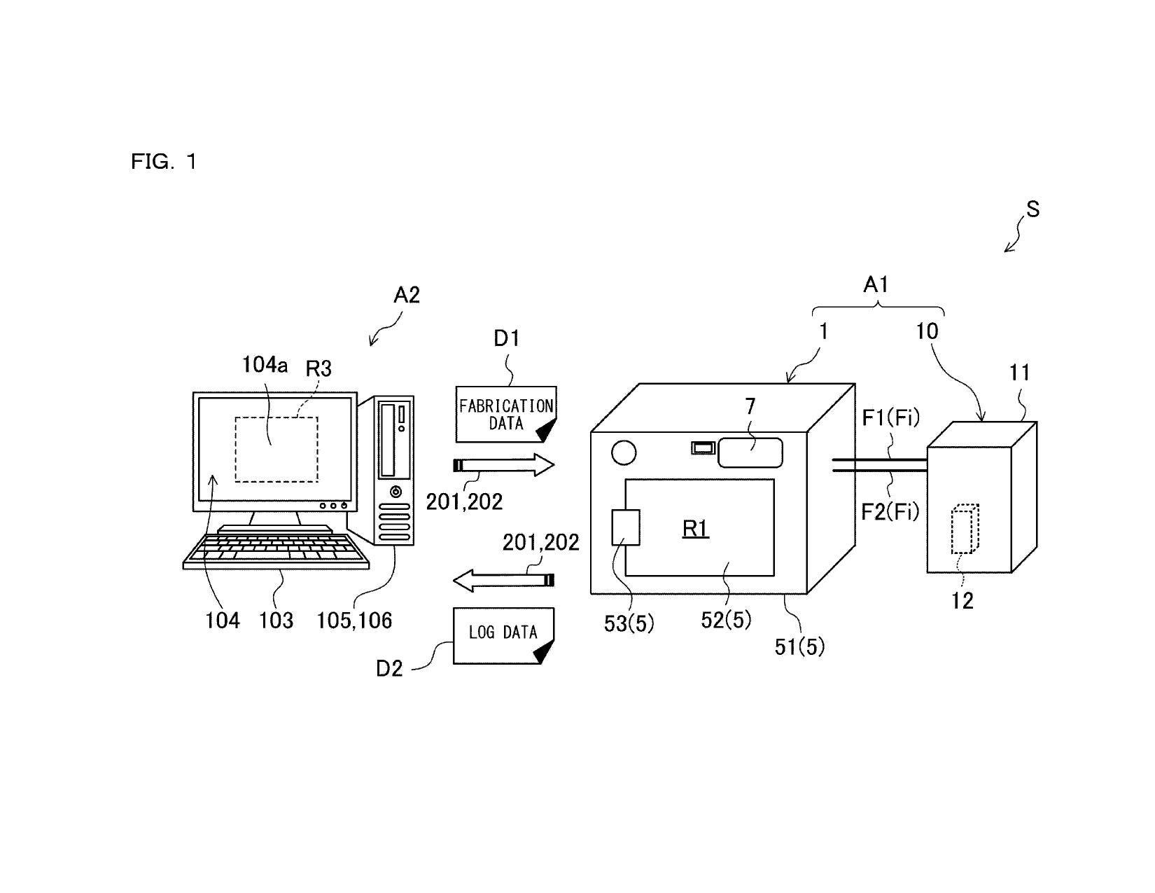

FIG. 1 is a diagram illustrating an overall configuration of a three-dimensional fabrication system S.

As illustrated in FIG. 1, the three-dimensional fabrication system S includes a three-dimensional fabrication apparatus A1 and a fabrication data creation apparatus A2 used in the three-dimensional fabrication apparatus A1.

The three-dimensional fabrication apparatus A1 is a fused filament fabrication (FFF) type three-dimensional fabrication apparatus. The fused filament fabrication type is a fabrication type configured to fabricate the three-dimensional fabrication object Ob by extruding the fused filament Fi to a fabrication plate 21 described later.

The fabrication data creation apparatus A2 is an apparatus that creates the fabrication data D1 used in the three-dimensional fabrication apparatus A1. The fabrication data creation apparatus A2 is configured by, for example, a desktop computer or a laptop computer connected to the three-dimensional fabrication apparatus A1.

The fabrication data D1 is, for example, a set of commands input to each part of the three-dimensional fabrication apparatus A1. Each command constituting the fabrication data D1 specifies the operation and control target of the component of the three-dimensional fabrication apparatus A1. The fabrication data D1 is information indicating details of a “fabrication job” executed by the three-dimensional fabrication apparatus A1. For example, in the present embodiment, one fabrication data D1 corresponds to one fabrication job. Details of the operation designated by each command constituting the fabrication data D1 will be described later.

The fabrication data creation apparatus A2 is connected to the three-dimensional fabrication apparatus A1 so as to enable data communication. Through this connection, the fabrication data creation apparatus A2 transmits the fabrication data D1 to the three-dimensional fabrication apparatus A1, and the three-dimensional fabrication apparatus A1 transmits the log data D2 indicating the fabrication result to the fabrication data creation apparatus A2. Note that it is not essential to transmit and receive the log data D2 between the three-dimensional fabrication apparatus A1 and the fabrication data creation apparatus A2.

The connection between the fabrication data creation apparatus A2 and the three-dimensional fabrication apparatus A1 may be a wireless or wired connection via a communication network 201 such as a local area network or the Internet.

In addition, the fabrication data D1 and the log data D2 may be transmitted and received between the fabrication data creation apparatus A2 and the three-dimensional fabrication apparatus A1 via a tangible storage medium 202. The storage medium 202 is, for example, a flash drive.

### 2. Configuration of three-dimensional fabrication apparatus A1

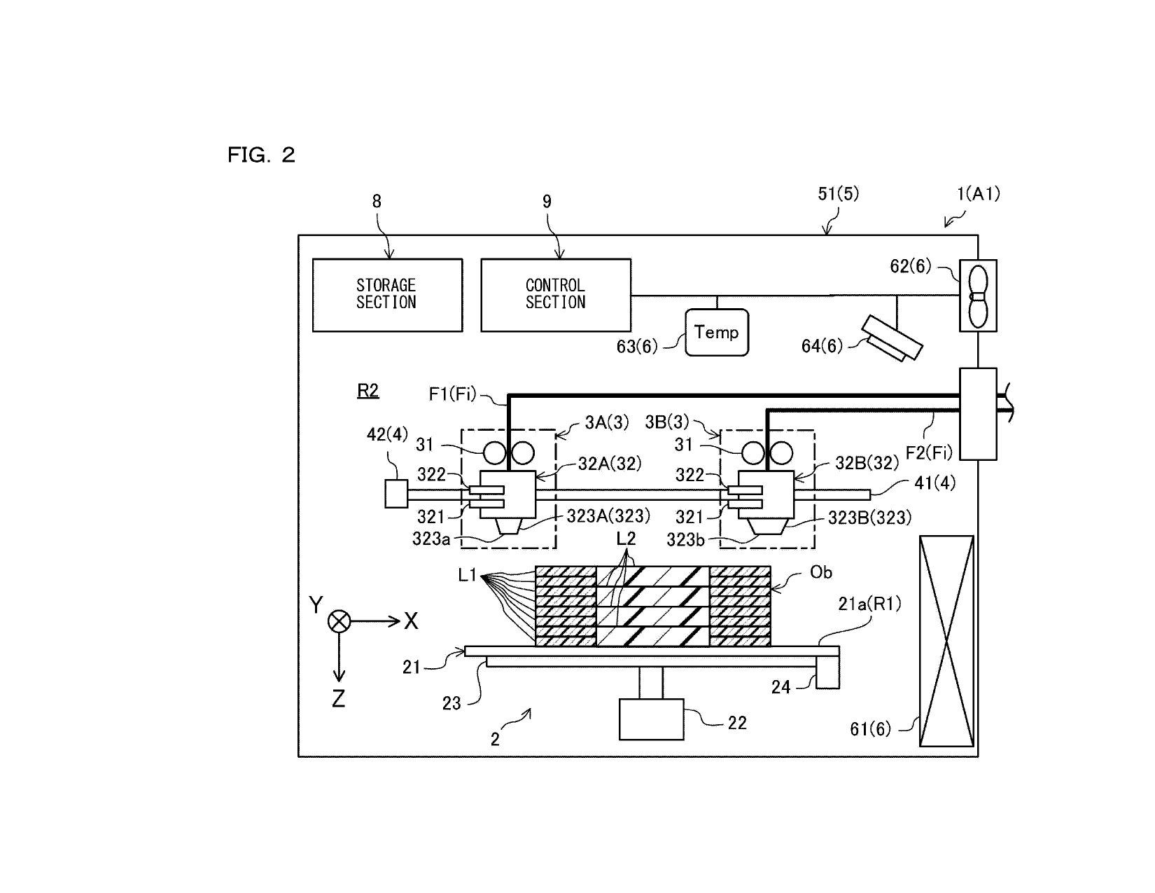

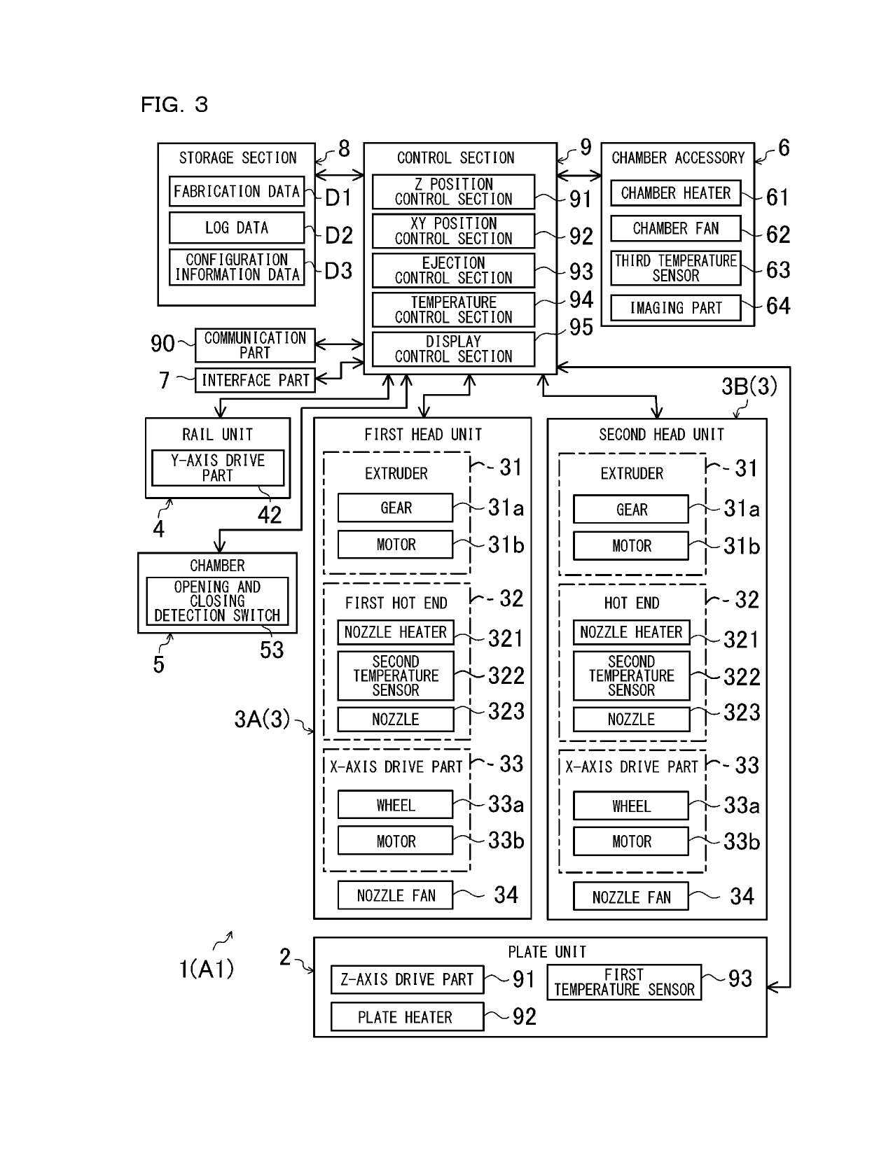

FIG. 2 is a schematic diagram illustrating a built-in structure of the three-dimensional fabrication apparatus A1 in the three-dimensional fabrication system S, and FIG. 3 is a functional block diagram illustrating a schematic configuration of the three-dimensional fabrication apparatus A1.

Note that, in the following description, a “Z direction” corresponds to a height direction of the three-dimensional fabrication apparatus A1. The Z direction can be rephrased as a direction extending parallel to a lowering direction of the fabrication plate 21. The Z direction coincides or substantially coincides with the gravity direction.

Similarly, in the following description, an “X direction” and a “Y direction” correspond to a width direction and a depth direction of the three-dimensional fabrication apparatus A1. The X direction and the Y direction may be collectively referred to as an "XY direction". The XY direction is a direction orthogonal to the Z direction. The XY direction coincides or substantially coincides with a horizontal direction.

As illustrated in FIGS. 2 and 3, the three-dimensional fabrication apparatus A1 according to the present embodiment is configured by a combination of the supply module 10 and the fabrication module 1. The supply module 10 is an example of a “supply part” in the present embodiment.

### 2-1. Supply module 10

The supply module 10 supplies the filament Fi before being fused. Specifically, the supply module 10 is configured to supply, to the fabrication module 1, one or more filaments Fi before being fused.

The supply module 10 according to the present embodiment is configured to accommodate two filaments Fi, respectively, and supply them to the fabrication module 1. Each of the two filaments Fi is a thermoplastic resin. Each of the two filaments Fi is accommodated in a state of being wound around a spool.

Hereinafter, one of the two filaments Fi may be referred to as a “first filament F1”, and the other of the two filaments Fi may be referred to as a “second filament F2”. The first filament F1 and the second filament F2 may be thermoplastic resins of the same type or thermoplastic resins of different types.

Specifically, the supply module 10 according to the present embodiment includes a container 11 that accommodates the filament Fi wound around the spool, and a filament heater 12 that heats and dries the inside of the container 11. The supply module 10 can be rephrased as a "filament dryer".

The container 11 accommodates the two filaments Fi wound around a spool. Each filament Fi is fed out from the container 11 and then inserted into the fabrication module 1.

The filament heater 12 heats the supply module 10 by operating with power consumption corresponding to the supply module 10. As an example, the filament heater 12 according to the present embodiment is configured by a heater attached to the container 11. The filament heater 12 is electrically connected to the fabrication module 1 or the fabrication data creation apparatus A2, and generates heat in response to a control signal from the fabrication module 1 or the fabrication data creation apparatus A2.

### 2-2. Fabrication module 1

As illustrated in FIG. 2, the fabrication module 1 includes a plate unit 2, one or a plurality of head units 3, a rail unit 4, a chamber 5, a chamber accessory 6, an interface part 7, a storage section 8, and a control section 9.

Here, in the present embodiment, one or more head units 3 are configured by two head units 3. Hereinafter, one of the two head units 3 may be referred to as a “first head unit 3A”, and the other of the two head units 3 may be referred to as a “second head unit 3B”.

### 2-2-1. Plate unit 2

As illustrated in FIGS. 2 and 3, the plate unit 2 includes a fabrication plate 21, a Z-axis drive part 22, a plate heater 23, and a first temperature sensor 24.

The fabrication plate 21 constitutes a fabrication region R1 of the three-dimensional fabrication object Ob. The filament Fi supplied from the supply module 10 is ejected from the nozzle 323 of the head unit 3 and stacked in the fabrication region R1. The fabrication plate 21 can be paraphrased as a “fabrication bed”.

Specifically, the fabrication plate 21 includes a flat upper surface 21a. The upper surface 21a extends flat along the XY direction and faces the nozzle 323 with a space therebetween in the Z direction. The upper surface 21a defines a fabrication region R1 on the fabrication plate 21.

The Z-axis drive part 22 supports the fabrication plate 21 from below with respect to an inner bottom portion of the chamber 5. The Z-axis drive part 22 includes a member displaceable or expandable in the Z direction and an actuator that operates the member. The actuator is, for example, a motor.

The Z-axis drive part 22 is electrically connected to the control section 9, and receives a control signal from the control section 9 to activate the actuator. When the actuator is activated, the fabrication plate 21 is raised or lowered. For example, when fabricating the three-dimensional fabrication object Ob, the fabrication plate 21 is lowered in stages. The distance (distance in the Z direction) between each head unit 3 and the fabrication plate 21 can be changed by moving the fabrication plate 21 in the Z direction.

The plate heater 23 heats the fabrication plate 21 by operating with power consumption corresponding to the fabrication plate 21. As an example, the plate heater 23 according to the present embodiment is configured by a heater fixed to the fabrication plate 21. The plate heater 23 is electrically connected to the control section 9 and generates heat according to a control signal from the control section 9.

The first temperature sensor 24 detects the temperature of the fabrication plate 21. The first temperature sensor 24 is electrically connected to the control section 9, and inputs a detection signal indicating a detection temperature of the fabrication plate 21 to the control section 9.

### 2-2-2. First head unit 3A

The first head unit 3A includes an X-axis drive part 33 and a nozzle fan 34. An extruder 31 and a hot end 32 are also fixed to the first head unit 3A. The first head unit 3A is movable along a direction in which the fabrication plate 21 spreads. Here, the direction in which the fabrication plate 21 spreads coincides with a direction orthogonal to the lowering direction (Z direction) of the fabrication plate 21, for example, the horizontal direction (XY direction) in the present embodiment.

The extruder 31 is configured to draw in and extrude downward the first filament F1 supplied from the supply module 10. The first filament F1 is drawn in downward from above. The first filament F1 extruded by the extruder 31 is supplied to the hot end 32. The extruder 31 is an example of an “extrusion part” and a “first extrusion part” in the present embodiment.

The extruder 31 is operable to draw in and pull back upward the first filament F1 supplied from the supply module 10. The first filament F1 is drawn in upward from below.

Specifically, the extruder 31 according to the present embodiment includes a gear 31a that meshes with the first filament F1 and a motor 31b that rotates the gear 31a.

The rotation direction of the motor 31b can be switched between the forward rotation direction and the reverse rotation direction. The rotation direction of the gear 31a can also be switched according to the rotation direction of the motor 31b. The direction in which the first filament F1 is drawn in is also switched according to the rotation direction of the gear 31a.

The extruder 31 is electrically connected to the control section 9, and receives a control signal from the control section 9 to rotate the motor 31b forward or backward. When the gear 31a rotates forward or backward according to the rotation direction of the motor 31b, the gear 31a rotates to extrude the first filament F1 downward, or the gear 31a rotates to pull back the first filament F1 upward.

The hot end 32 is configured to fuse the filament Fi extruded by the extruder 31 and eject the fused first filament F1 to the fabrication plate 21. The hot end 32 is an example of a "nozzle member" and a "first nozzle member" in the present embodiment. Hereinafter, the hot end 32 in the first head unit 3A is referred to as a “first hot end”, and reference sign “32A” may be attached to the hot end (see FIG. 2).

Specifically, the hot end 32 according to the present embodiment includes a nozzle heater 321, a second temperature sensor 322, and a nozzle 323.

The nozzle heater 321 heats the hot end 32 by operating with power consumption corresponding to the hot end 32. By heating the hot end 32, the first filament F1 extruded by the extruder 31 and passing through the hot end 32 is fused. As an example, the nozzle heater 321 according to the present embodiment is configured by a heater fixed to the hot end 32. The nozzle heater 321 is electrically connected to the control section 9 and generates heat according to a control signal from the control section 9.

The second temperature sensor 322 detects a temperature of the hot end 32. The second temperature sensor 322 is electrically connected to the control section 9, and inputs a detection signal indicating a detection temperature of the hot end 32 to the control section 9.

The nozzle 323 includes a first nozzle outlet 323a facing the upper surface 21a of the fabrication plate 21. The nozzle 323 ejects the first filament F1 heated and fused by the nozzle heater 321 from the first nozzle outlet 323a. Hereinafter, the nozzle 323 fixed to the first head unit 3A may be referred to as a “first nozzle 323A”.

By extruding the first filament F1 ejected from the first nozzle outlet 323a to the fabrication plate 21, the first filament layer L1 constituting the three-dimensional fabrication object Ob is stacked.

The X-axis drive part 33 connects the first head unit 3A to the rail member 41 of the rail unit 4. The X-axis drive part 33 includes a wheel 33a and a motor 33b that rotates the wheel 33a. When the wheel 33a rotates, the first head unit 3A can be moved along a longitudinal direction (X direction) of the rail member 41.

A rotation direction of the motor 33b can be switched between a forward rotation direction and a reverse rotation direction. A rotation direction of the wheel 33a can also be switched according to the rotation direction of the motor 33b. A moving direction of the first head unit 3A is also switched according to the rotation direction of the wheel 33a.

The X-axis drive part 33 is electrically connected to the control section 9, and receives a control signal from the control section 9 to rotate the motor 33b forward or backward. When the wheel 33a rotates forward or backward according to the rotation direction of the motor 33b, the wheel 33a rotates to move the first head unit 3A in the +X direction, or the wheel 33a rotates to move the first head unit 3A in the -X direction. By rotating the wheel 33a, the first head unit 3A can be moved in the X direction. The configuration related to the movement in the X direction is similar in the X-axis drive part 33 of the second head unit 3B described later.

The nozzle fan 34 is configured to cool the first head unit 3A by blowing air to the first head unit 3A. The nozzle fan 34 is electrically connected to the control section 9, and executes an air blowing operation on the basis of a control signal input from the control section 9.

### 2-2-3. Second head unit 3B

The second head unit 3B includes an X-axis drive part 33 and a nozzle fan 34. The extruder 31 and the hot end 32 are also fixed to the second head unit 3B. The second head unit 3B is movable along the direction in which the fabrication plate 21 spreads. Here, the direction in which the fabrication plate 21 spreads coincides with a direction orthogonal to the lowering direction (Z direction) of the fabrication plate 21, for example, the horizontal direction (XY direction) in the present embodiment.

The extruder 31 is configured to draw in and extrude downward the second filament F2 supplied from the supply module 10. The second filament F2 is drawn in downward from above.

The configuration of the extruder 31 of the second head unit 3B is substantially the same as the configuration of the extruder 31 of the first head unit 3A except that the operation related to the second filament F2 is performed instead of the first filament F1. The extruder 31 is an example of an “extrusion part” and a “second extrusion part” in the present embodiment.

The extruder 31 is operable to draw in and pull back upward the second filament F2 supplied from the supply module 10. The second filament F2 is drawn in upward from below.

Specifically, the extruder 31 according to the present embodiment includes a gear 31a that meshes with the second filament F2 and a motor 31b that rotates the gear 31a. As described above, these configurations are substantially the same as those of the first head unit 3A.

The hot end 32 is configured to fuse the filament Fi extruded by the extruder 31 and eject the fused second filament F2 to the fabrication plate 21. The hot end 32 is an example of a "nozzle member" and a "second nozzle member" in the present embodiment. Hereinafter, the hot end 32 in the second head unit 3B is referred to as a “second hot end”, and reference sign “32B” may be attached to the hot end (see FIG. 2).

The configuration of the hot end 32 of the second head unit 3B is substantially the same as the configuration of the hot end 32 of the first head unit 3A except that the operation related to the second filament F2 is performed instead of the first filament F1 and the configuration related to the nozzle 323. For example, the hot end 32 of the second head unit 3B includes a second temperature sensor 322 that detects the temperature of the hot end 32 and inputs a detection signal indicating the detected temperature to the control section 9.

Specifically, the hot end 32 according to the present embodiment includes a nozzle heater 321, a second temperature sensor 322, and a nozzle 323. As described above, the configurations of the nozzle heater 321 and the second temperature sensor 322 are substantially the same as those of the first head unit 3A.

The nozzle 323 includes a second nozzle outlet 323b facing the upper surface 21a of the fabrication plate 21. The second nozzle outlet 323b has a larger diameter than the first nozzle outlet 323a of the first head unit 3A as the first nozzle member. The second nozzle outlet 323b having a relatively large diameter ejects the second filament F2 heated and fused by the nozzle heater 321 of the second head unit 3B. Hereinafter, the nozzle 323 fixed to the second head unit 3B may be referred to as a “second nozzle 323B”.

Note that it is not essential that the second nozzle outlet 323b has a larger diameter than the first nozzle outlet 323a. For example, in a parallel fabrication mode M12 to be described later, the second nozzle outlet 323b has the same diameter as the first nozzle outlet 323a. Setting the second nozzle outlet 323b and the first nozzle outlet 323a to have different diameters is particularly effective in the speed fabrication mode M21 to be described later.

The second filament F2 ejected from the second nozzle outlet 323b is extruded to the fabrication plate 21 to stack the second filament layer L2 constituting the three-dimensional fabrication object Ob.

In addition, the configurations of the X-axis drive part 33 and the nozzle fan 34 are substantially the same as those of the first head unit 3A. For example, the X-axis drive part 33 of the second head unit 3B connects the second head unit 3B to the rail member 41 of the rail unit 4.

### 2-2-4. Rail unit 4

The rail unit 4 moves the first head unit 3A and the second head unit 3B in a direction orthogonal to a lowering direction (Z direction) of the fabrication plate 21, for example, in the horizontal direction (XY direction).

Specifically, as illustrated in FIGS. 2 and 3, the rail unit 4 according to the present embodiment includes a rail member 41 and a Y-axis drive part 42.

The rail member 41 is a long and rail-shaped member extending in the X direction. The first head unit 3A and the second head unit 3B are coupled to the rail member 41. Each of the first head unit 3A and the second head unit 3B is movable in the X direction along the rail member 41.

The Y-axis drive part 42 supports the rail member 41 on an inner wall of the chamber 5. The Y-axis drive part 42 includes a member that is displaceable in the Y direction and an actuator that displaces the member. The actuator is, for example, a motor.

The Y-axis drive part 42 is electrically connected to the control section 9, and activates the actuator by receiving a control signal from the control section 9. When the actuator is activated, the rail member 41 moves in the Y direction. The first head unit 3A and the second head unit 3B can be moved in the Y direction, respectively, by moving the rail member 41 in the Y direction.

### 2-2-5. Chamber 5

As illustrated in FIG. 2, the chamber 5 accommodates the extruder 31, the hot end 32, and the fabrication plate 21, and includes a fabrication space (space including a fabrication region R1) formed above the fabrication plate 21.

Specifically, the chamber 5 accommodates the plate unit 2, the first head unit 3A and the second head unit 3B, the rail unit 4, the chamber accessory 6, the storage section 8, and the control section 9.

Specifically, as illustrated in FIG. 1, the chamber 5 according to the present embodiment includes a housing 51, an opening and closing door 52, and an opening and closing detection switch 53.

The housing 51 surrounds the extruder 31, the hot end 32, and the fabrication plate 21. The fabrication region R1 is configured in the internal space R2 of the housing 51.

The opening and closing door 52 opens and closes the housing 51. The open and close state of the opening and closing door 52 is detected by the opening and closing detection switch 53. The opening and closing detection switch 53 is electrically connected to the control section 9, and inputs a detection signal indicating the opening and closing state to the control section 9.

### 2-2-6. Chamber accessory 6

As illustrated in FIG. 2, the chamber accessory 6 includes a chamber heater 61, a chamber fan 62, a third temperature sensor 63, and an imaging part 64.

The chamber heater 61 heats the inside of the chamber 5. By this heating, the inside temperature of the chamber 5, for example, the temperature of the fabrication region R1 is adjusted. The chamber heater 61 is electrically connected to the control section 9 and generates heat according to a control signal from the control section 9.

The chamber fan 62 blows air into the chamber 5. The inside temperature of the chamber 5 is adjusted by this air blowing. The chamber fan 62 is electrically connected to the control section 9 and executes air blowing in response to a control signal from the control section 9.

The third temperature sensor 63 detects the inside temperature of the chamber 5. The third temperature sensor 63 is electrically connected to the control section 9, and inputs a detection signal indicating a detected temperature of the inside temperature to the control section 9.

The imaging part 64 images the fabrication region R1 to generate a captured image of the fabrication region R1 before the start of fabrication, the three-dimensional fabrication object Ob in the middle of fabrication, or the completed three-dimensional fabrication object Ob. The imaging part 64 includes, for example, a camera that performs imaging with visible light. The imaging part 64 is electrically connected to the control section 9 or the fabrication data creation apparatus A2, and inputs an electric signal indicating the generated captured image to the control section 9 or the fabrication data creation apparatus A2.

### 2-2-7. Interface part 7

As illustrated in FIG. 1, the interface part 7 is disposed on the outer surface of the chamber 5. The interface part 7 includes a reception part that receives an operation input by the user and a notification part that notifies the user of information.

Specifically, the interface part 7 according to the present embodiment includes a touch panel that serves as both the reception part and the notification part. The interface part 7 is electrically connected to the control section 9. The interface part 7 inputs an electric signal corresponding to an operation input by the user to the control section 9, and displays information to be notified to the user on the basis of the electric signal input from the control section 9.

### 2-2-8. Storage section 8

The storage section 8 stores electronic data related to the fabrication of the three-dimensional fabrication object Ob. The storage section 8 is incorporated in the fabrication module 1. Specifically, in the present embodiment, the storage section 8 is incorporated in the housing 51 of the fabrication module 1. As will be described later, the storage section 8 stores the configuration information Di including information indicating the type of the replacement member Pe, and exemplifies a “configuration storage part” in the present embodiment.

As illustrated in FIG. 3, the electronic data stored by the storage section 8 includes configuration information data D3 and a control program (not illustrated) in addition to the fabrication data D1 and the log data D2 transmitted and received to and from the fabrication data creation apparatus A2. For example, the control program is a program in which various processes executed by the control section 9 are coded, such as an operation program of the head unit 3. Details of other data will be described later. Transmission and reception of electronic data between the storage section 8 and the fabrication data creation apparatus A2 is executed via the communication part 90 illustrated in FIG. 3.

Specifically, the storage section 8 according to the present embodiment includes a non-volatile memory such as a solid state drive (SSD) or a hard disk drive (HHD). The storage section 8 is electrically connected to the control section 9. The storage section 8 transmits and receives the above-described electronic data to and from the control section 9.

### 2-2-9. Control section 9

The control section 9 controls at least one of the plurality of head units 3 so that the three-dimensional fabrication object Ob is fabricated by the filament Fi ejected from the head unit 3 as the nozzle member. The storage section 8 is incorporated in the fabrication module 1. Specifically, in the present embodiment, the storage section 8 is incorporated in the housing 51 of the fabrication module 1. The control section 9 is an example of a "control part" in the present embodiment.

Specifically, the control section 9 is electrically connected to the plurality of head units 3 individually. The control section 9 individually controls the plurality of head units 3 by executing the control program. The control section 9 executes the fabrication of the three-dimensional fabrication object Ob by individually controlling each of the plurality of head units 3.

Specifically, the control section 9 is a computer including a processor, a RAM, a ROM, and an input/output bus. The control section 9 is electrically connected to the first head unit 3A, the second head unit 3B, the rail unit 4, the chamber 5, the chamber accessory 6, the interface part 7, and the storage section 8, and transmits and receives signals to and from these devices.

For example, the control section 9 generates a control signal on the basis of detection signals received from the first temperature sensor 24, the second temperature sensor 322 of each of the plurality of head units 3, the opening and closing detection switch 53, and the third temperature sensor 63, and the contents stored in the storage section 8.

The control section 9 inputs the generated control signal to the Z-axis drive part 22, the X-axis drive part 33 of each head unit 3, and the Y-axis drive part 42 to execute the movement of the fabrication plate 21 along the Z-axis direction and the movement of each head unit in the XY direction.

The control section 9 inputs the generated control signal to the extruder 31 of each head unit 3 to draw in the filament Fi corresponding to each head unit 3 from the supply module 10.

The control section 9 inputs the generated control signal to the filament heater 12, the plate heater 23, each nozzle heater 321, and the chamber heater 61 that individually heat the plurality of heating targets Th. Here, the plurality of heating targets Th includes the supply module 10, the fabrication plate 21, each head unit 3, and the chamber 5. As a result, the filament heater 12, the plate heater 23, each nozzle heater 321, and the chamber heater 61 individually execute heating of each heating target Th.

For example, when the control section 9 executes heating by each nozzle heater 321, each filament Fi drawn in by each extruder 31 is fused and ejected from each nozzle 323.

The fabrication of the three-dimensional fabrication object Ob is executed by the fused resin ejected from each nozzle 323, that is, the fused filament Fi. The ejection position of the filament Fi is controlled by activating the X-axis drive part 33 and the Y-axis drive part 42 as described above. The distance in the Z direction between the ejection position of the filament Fi and the three-dimensional fabrication object Ob is controlled by activating the Z-axis drive part 22 as described above.

The three-dimensional fabrication object Ob fabricated by the filament Fi ejected in this manner is imaged by the imaging part 64. An electric signal indicating an image captured by the imaging part 64 is transmitted to the interface part 7 or the fabrication data creation apparatus A2 via the control section 9.

Furthermore, as described above, the temperature management during the fabrication can be executed by inputting a control signal to the plurality of heaters (filament heater 12, plate heater 23, each nozzle heater 321, and chamber heater 61) that respectively heat the plurality of heating targets Th and the plurality of air blowing section (the nozzle fan 34 and the chamber fan 62) that blow air to at least a part of the plurality of heating targets Th and activating these devices.

As illustrated in FIG. 3, the control section 9 according to the present embodiment can be classified into a Z position control section 91, an XY position control section 92, an ejection control section 93, a temperature control section 94, and a display control section 95 according to their main functions.

The Z position control section 91 controls the Z position (position in the Z direction) of the fabrication plate 21. The XY position control section 92 controls XY positions (positions in the X direction and the Y direction) of each head unit 3. The ejection control section 93 controls the ejection of the filament Fi from each head unit 3. The temperature control section 94 controls the temperature of each part of the fabrication module 1.

The processing performed by these functional blocks is executed by referring to the fabrication data D1, the configuration information data D3, and the like stored by the storage section 8. Hereinafter, the fabrication data creation apparatus A2 related to the creation of the fabrication data D1 will be described in detail.

### 3. Configuration of fabrication data creation apparatus A2

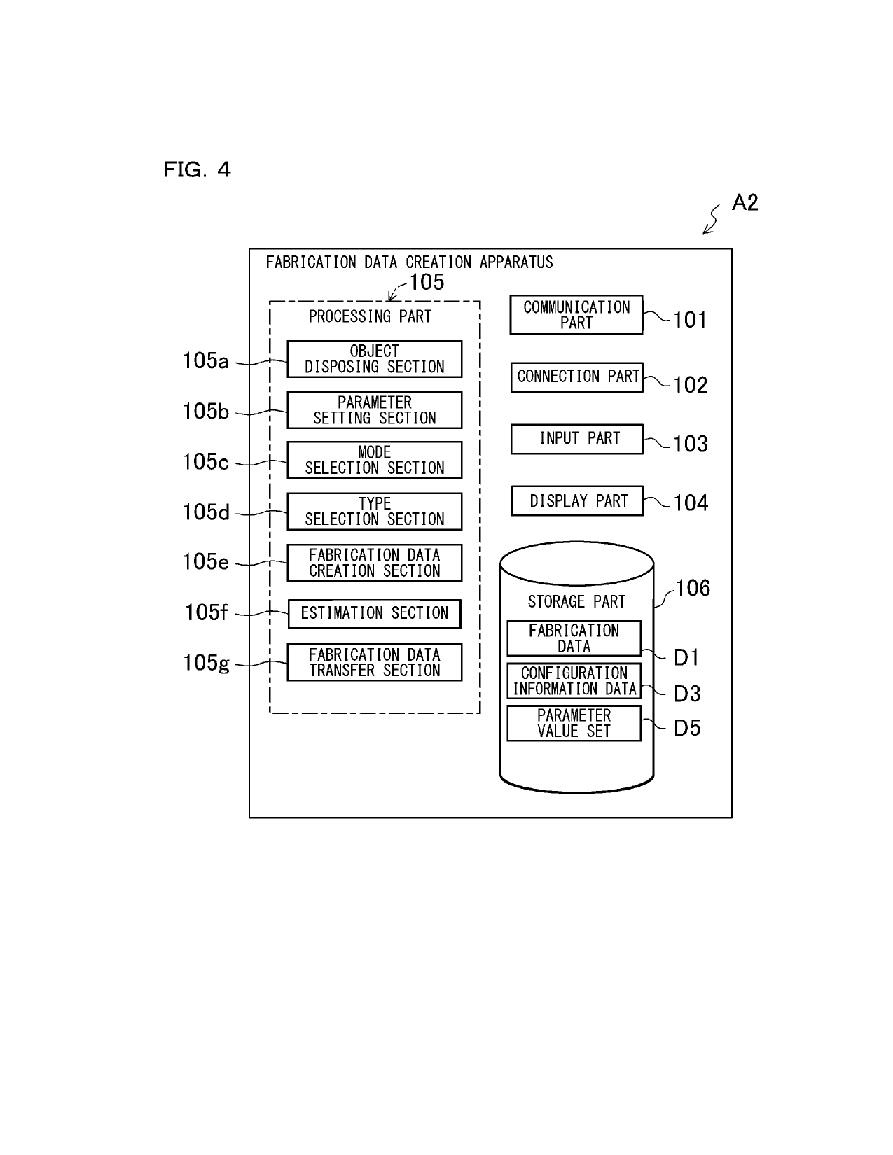

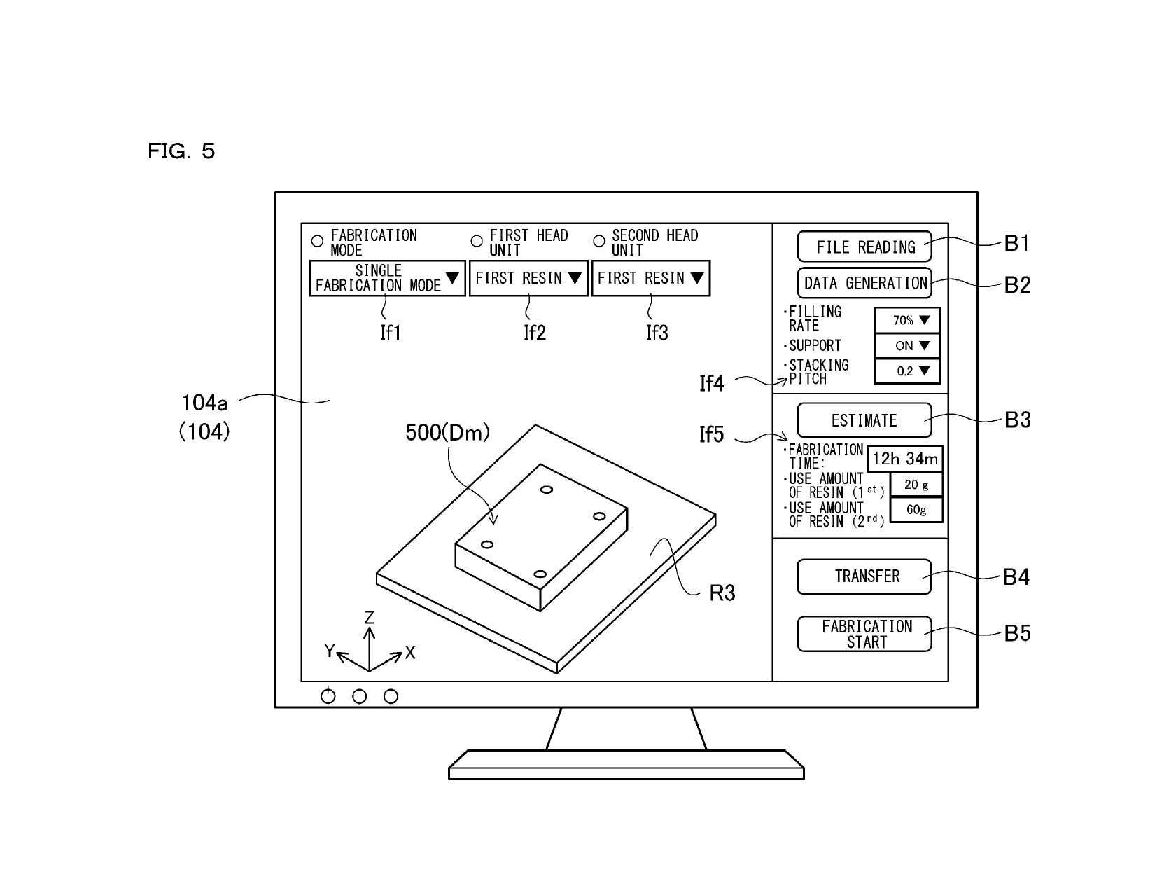

FIG. 4 is a functional block diagram illustrating a schematic configuration of the fabrication data creation apparatus A2 in the three-dimensional fabrication system S. FIG. 5 is a diagram illustrating a display screen 104a of the fabrication data creation apparatus A2.

The fabrication data creation apparatus A2 is connected to the three-dimensional fabrication apparatus A1 and functions as an external terminal that executes processing related to the three-dimensional fabrication apparatus A1. The fabrication data creation apparatus A2 is configured by, for example, a desktop computer or a laptop computer as described above.

Specifically, the fabrication data creation apparatus A2 includes a communication part 101, a connection part 102, an input part 103, a display part 104, a processing part 105, and a storage part 106. The communication part 101 transmits and receives electronic data to and from the three-dimensional fabrication apparatus A1. The connection part 102 transmits and receives electronic data to and from the storage medium 202. The input part 103 receives an operation and an input by the user. The display part 104 displays information to the user. The processing part 105 executes various processes. The storage part 106 stores information related to the processing part 105.

### 3-1. Communication part 101

The communication part 101 is connected to the communication part 90 of the three-dimensional fabrication apparatus A1 via the communication network 201. Through the connection via the communication network 201, the fabrication data creation apparatus A2 can remotely access the three-dimensional fabrication apparatus A1. This remote access enables the fabrication data creation apparatus A2 to remotely operate the three-dimensional fabrication apparatus A1.

The communication part 101 can also output the fabrication data D1 created by the fabrication data creation apparatus A2 to the three-dimensional fabrication apparatus A1 via the communication network 201. The communication part 101 exemplifies "output section" in the present embodiment.

The communication part 101 can also acquire the three-dimensional data Dm for fabricating the three-dimensional fabrication object Ob from another terminal other than the three-dimensional fabrication apparatus A1 via the Internet or a local area network. The communication part 101 exemplifies an “acquisition section” in the present embodiment together with the connection part 102 and the input part 103.

Here, the three-dimensional data Dm is electronic data that characterizes the three-dimensional shape of the three-dimensional fabrication object Ob. The three-dimensional data Dm is, for example, electronic data in a standard triangulated language (STL) format. The file format of the three-dimensional data Dm may be any format that can be used by the three-dimensional fabrication apparatus A1.

### 3-2. Connection part 102

The tangible storage medium 202 is connected to the connection part 102. The connection part 102 can acquire the three-dimensional data Dm from the storage medium 202 and store the fabrication data D1 in the storage medium 202. The connection part 102 illustrates another example of the “acquisition section” in the present embodiment in that the three-dimensional data Dm can be acquired.

Specifically, the connection part 102 according to the present embodiment includes an interface to which the storage medium 202 can be connected, such as a USB port. The fabrication data creation apparatus A2 can transmit and receive various electronic data including the three-dimensional data Dm and the fabrication data D1 to and from the storage medium 202 via the connection part 102.

### 3-3. Input part 103

The input part 103 can construct the three-dimensional data Dm on the fabrication data creation apparatus A2 by receiving manual operation (manual operation and input) by the user. The input part 103 illustrates another example of an “acquisition section” in the present embodiment in that the fabrication data creation apparatus A2 can acquire the three-dimensional data Dm by construction by manual operation.

Specifically, the input part 103 according to the present embodiment includes, for example, at least one of a keyboard and a pointing device. Here, the pointing device includes a mouse, a trackball, a joystick, and the like. The fabrication data creation apparatus A2 can receive various manual operations via the input part 103.

### 3-4. Display part 104

The display part 104 displays the fabrication plane R3 corresponding to the fabrication region R1 on the fabrication plate 21. The fabrication plane R3 is a virtual plane corresponding to the fabrication region R1. By setting the layout of the three-dimensional fabrication object Ob on the virtual plane, the three-dimensional fabrication object Ob corresponding to the layout can be actually fabricated on the fabrication region R1. The display part 104 is an example of a "display section" in the present embodiment.

In addition, the display part 104 can display a graphical user interface (GUI) capable of receiving various operation inputs for operating the fabrication data creation apparatus A2 and the three-dimensional fabrication apparatus A1. A manual operation can be input to the GUI via the input part 103.

Specifically, the display part 104 according to the present embodiment includes, for example, a liquid crystal display or an organic EL panel. As illustrated in FIG. 5, a display screen 104a on which the fabrication plane R3 is displayed is displayed on the surface of the display part 104.

### 3-5. Storage part 106

The storage part 106 stores electronic data indicating the fabrication data D1 itself of the three-dimensional fabrication object Ob and electronic data related to the setting. The storage part 106 is built in the fabrication data creation apparatus A2. The storage part 106 is an example of a “fabrication parameter storage section” in the present embodiment.

As illustrated in FIG. 3, the electronic data stored by the storage part 106 includes, in addition to the fabrication data D1 transmitted to and received from the three-dimensional fabrication apparatus A1, configuration information data D3 received from the three-dimensional fabrication apparatus A1, a parameter value set D5 stored in advance, and a setting program (not illustrated). For example, the setting program is a program in which various processes executed by the processing part 105, such as setting of the fabrication data D1, are coded. Details of other data will be described later.

Specifically, the storage part 106 according to the present embodiment includes a non-volatile memory such as a solid state drive (SSD) or a hard disk drive (HHD). The storage part 106 is electrically connected to the processing part 105. The storage part 106 transmits and receives the above-described electronic data to and from the processing part 105. Transmission and reception of electronic data between the storage part 106 and the processing part 105 are executed via an input/output bus.

### 3-6. Processing part 105

The processing part 105 executes various processes by executing a program stored in the storage part 106. The processing performed by the processing part 105 includes control of display contents on the display screen 104a, creation of the fabrication data D1, transmission of the fabrication data D1 to the three-dimensional fabrication apparatus A1, and remote control of the three-dimensional fabrication apparatus A1.

Specifically, the processing part 105 according to the present embodiment includes a processor, a RAM, a ROM, and an input/output bus. By executing the program, the processing part 105 functions as an object disposing section 105a, a parameter setting section 105b, a mode selection section 105c, a type selection section 105d, a fabrication data creation section 105e, an estimation section 105f, or a fabrication data transfer section 105g.

Hereinafter, a creation procedure of the fabrication data D1 by the fabrication data creation apparatus A2 will be described in detail while describing details of each functional element described above such as the object disposing section 105a.

### 4. Creation procedure of fabrication data D1

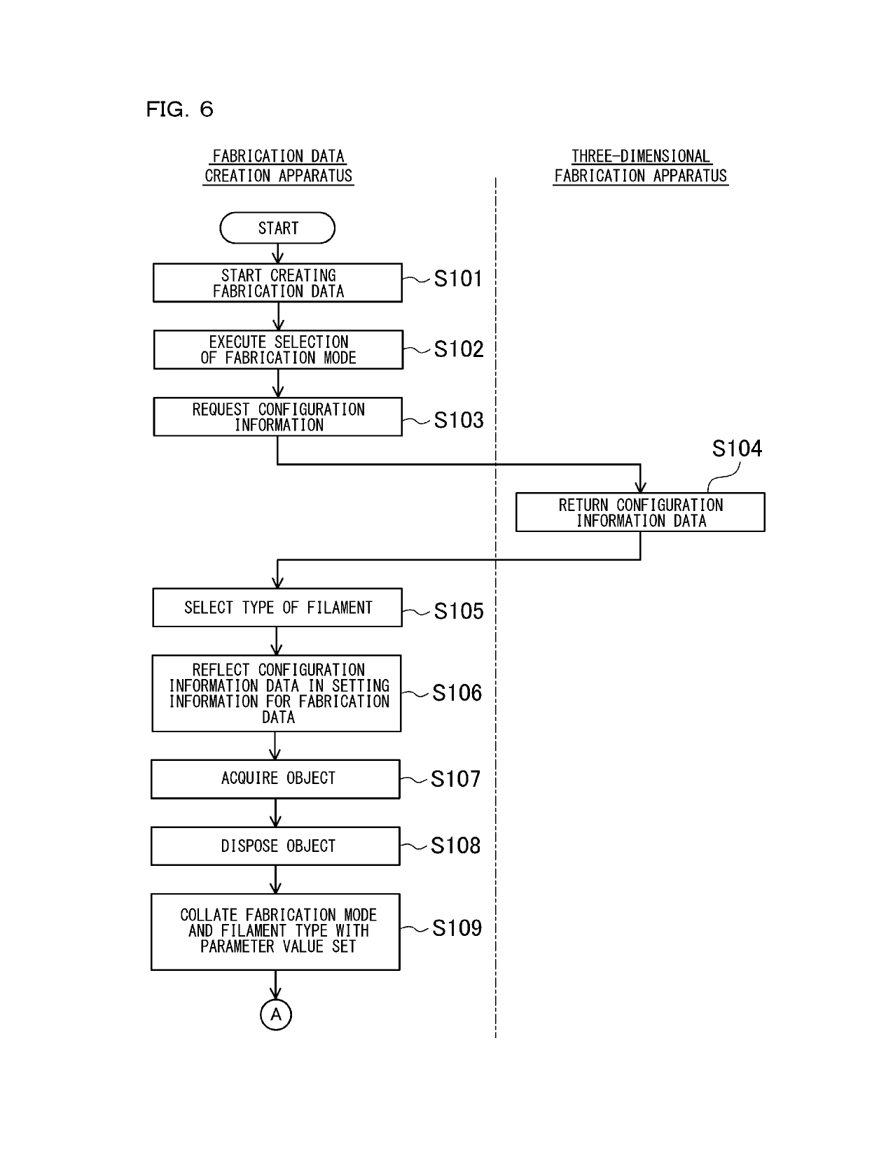

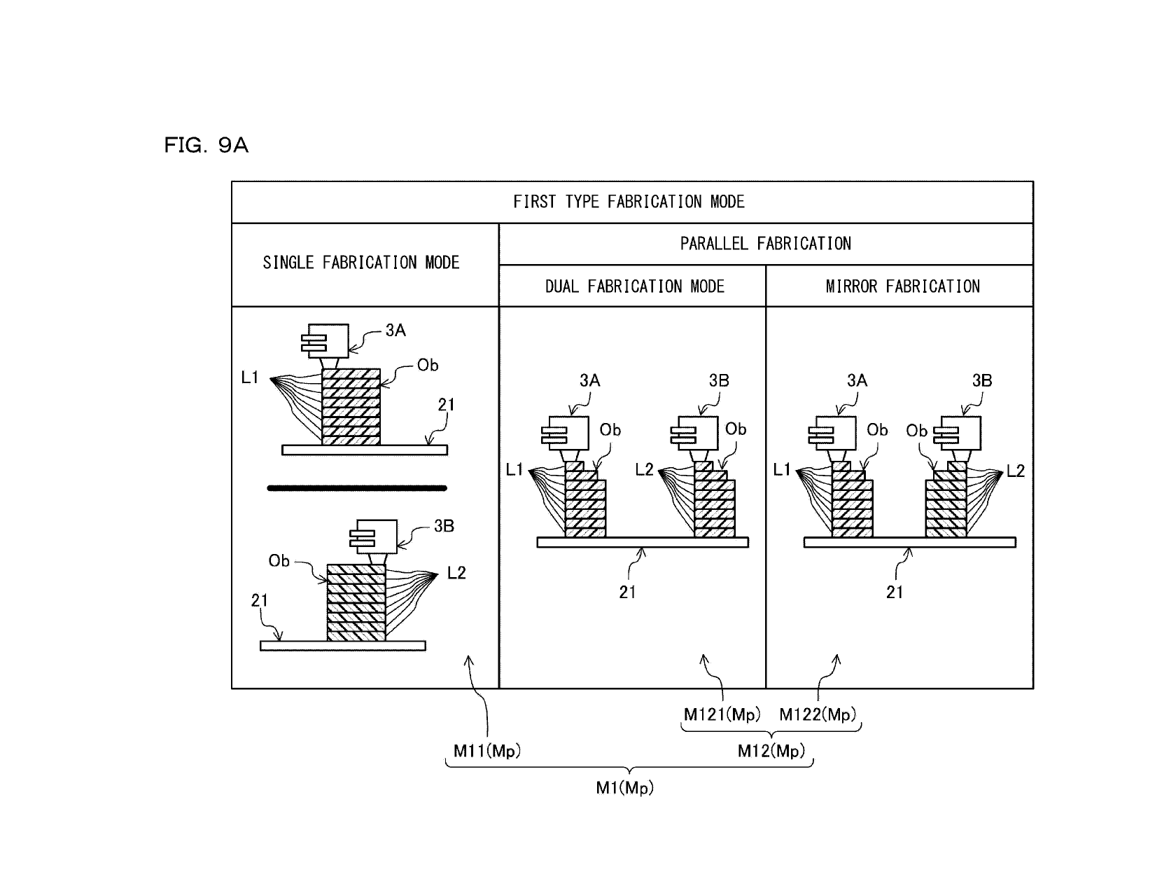

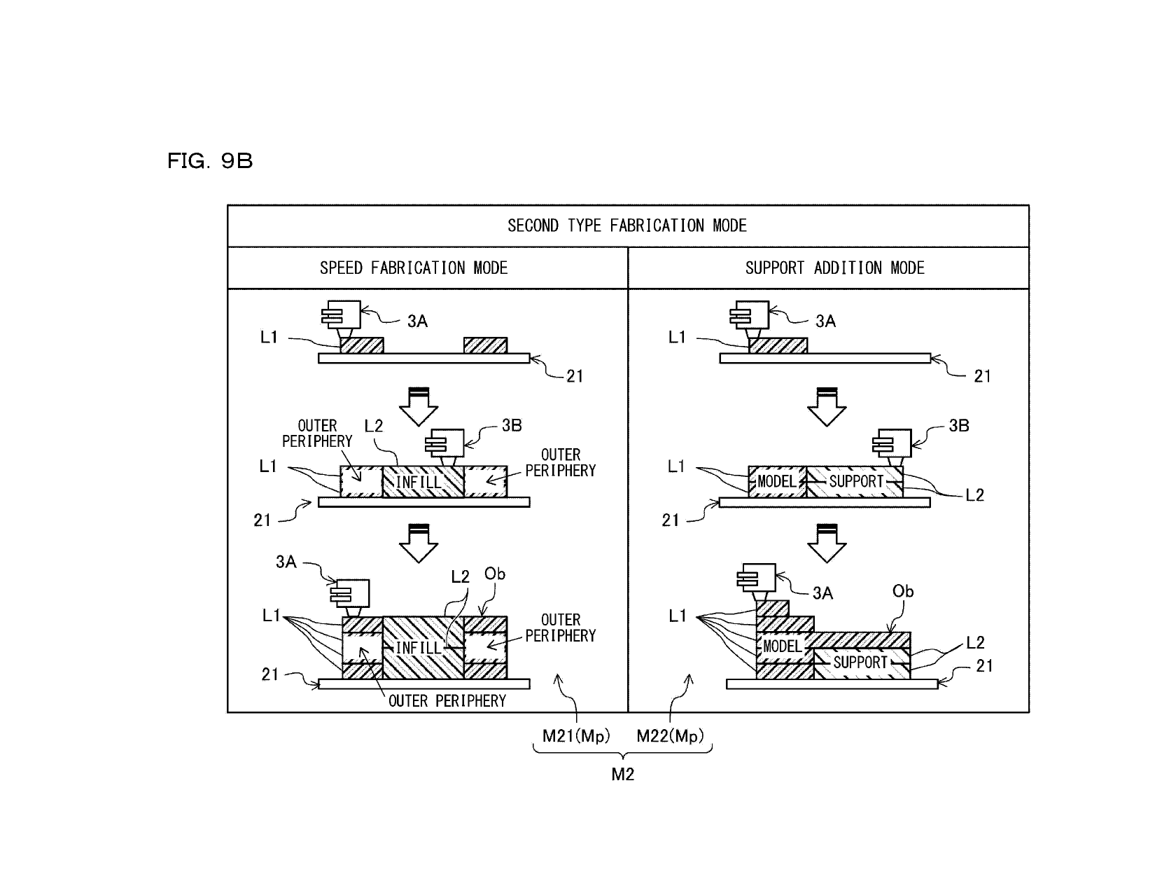

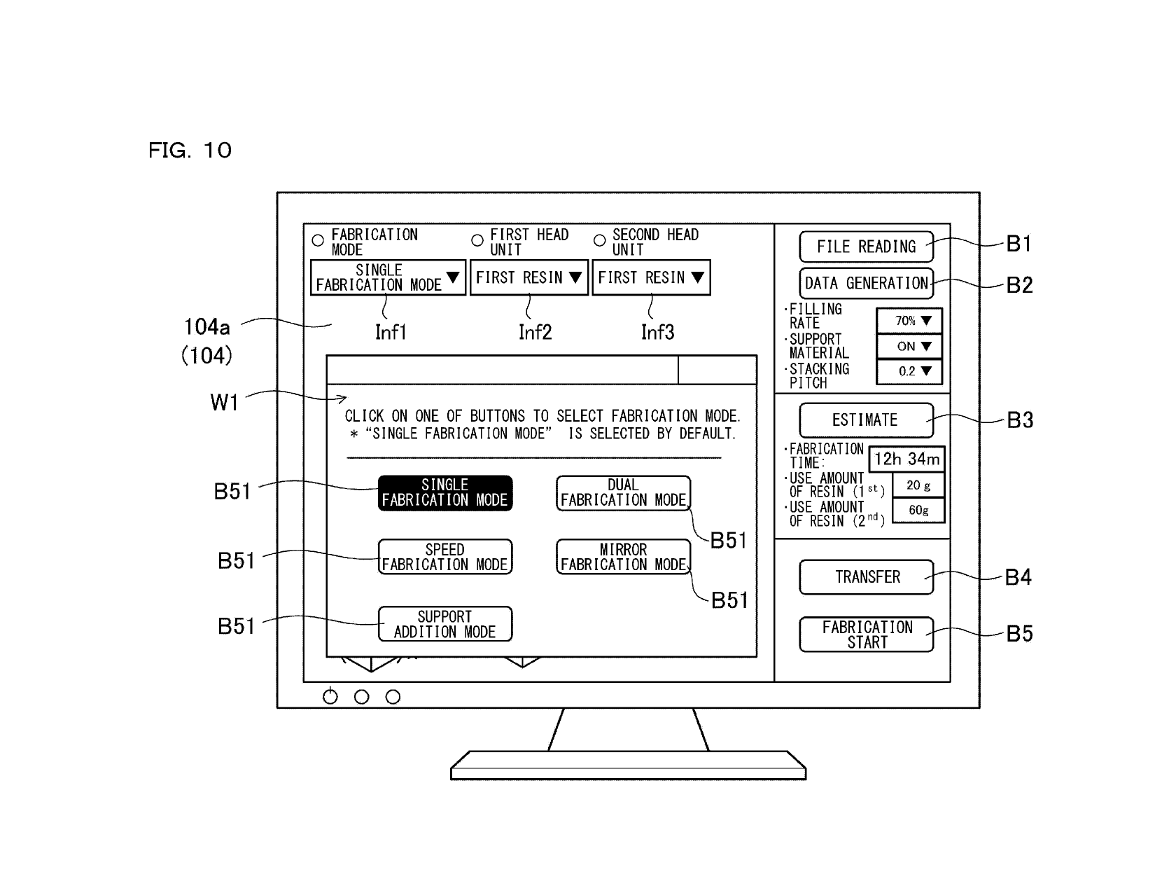

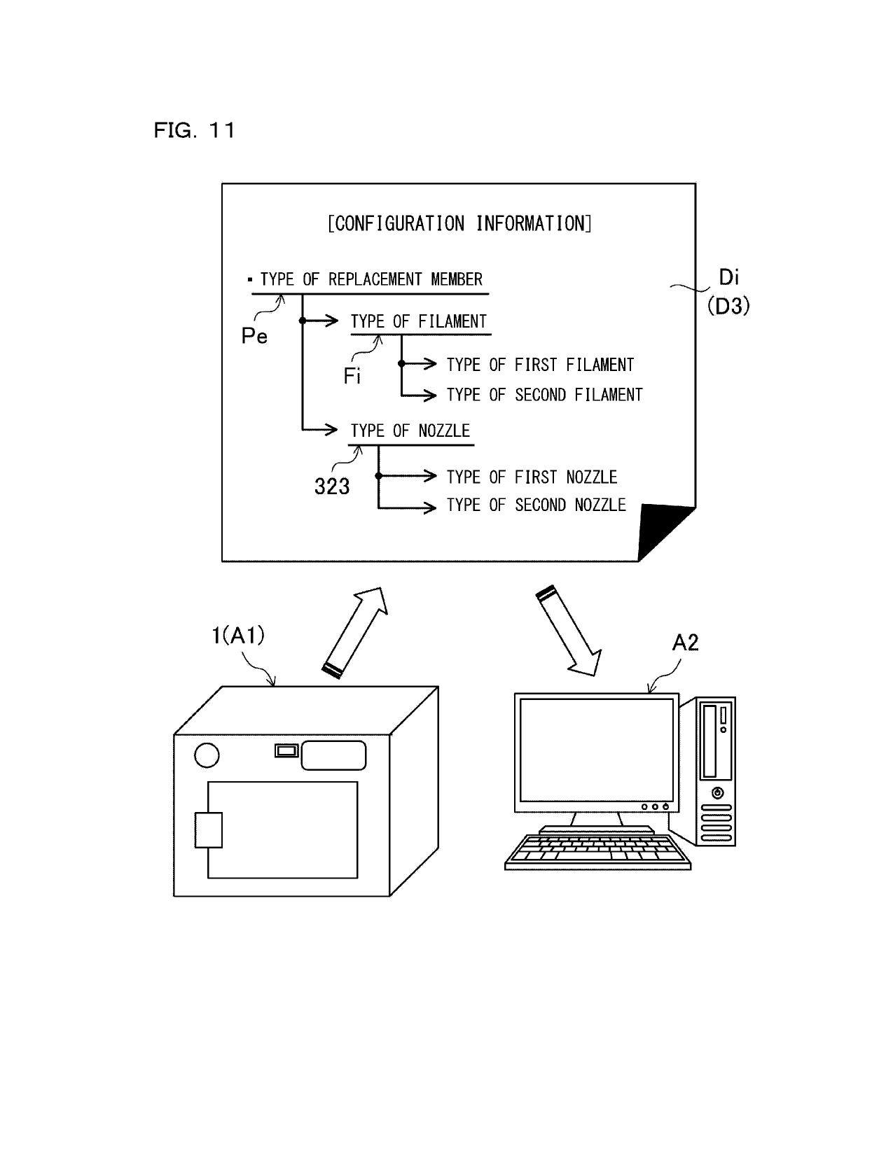

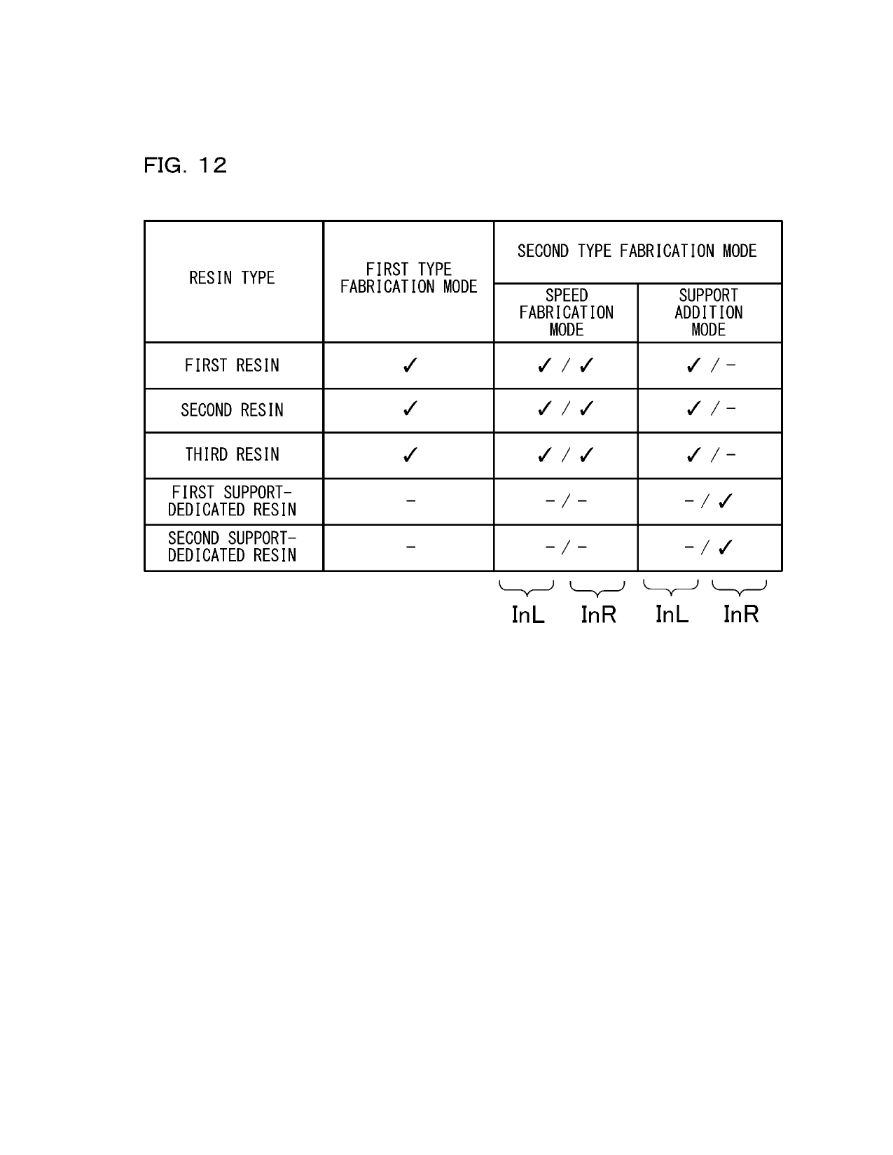

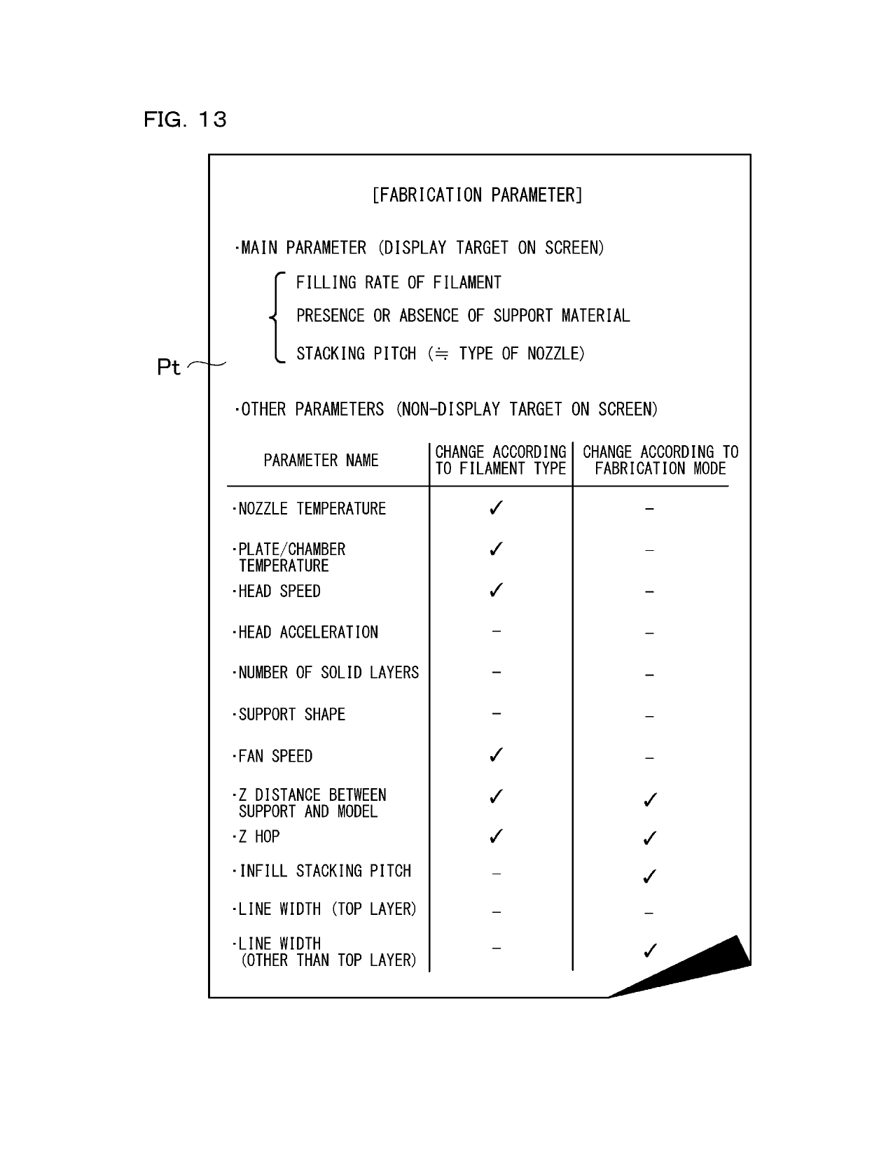

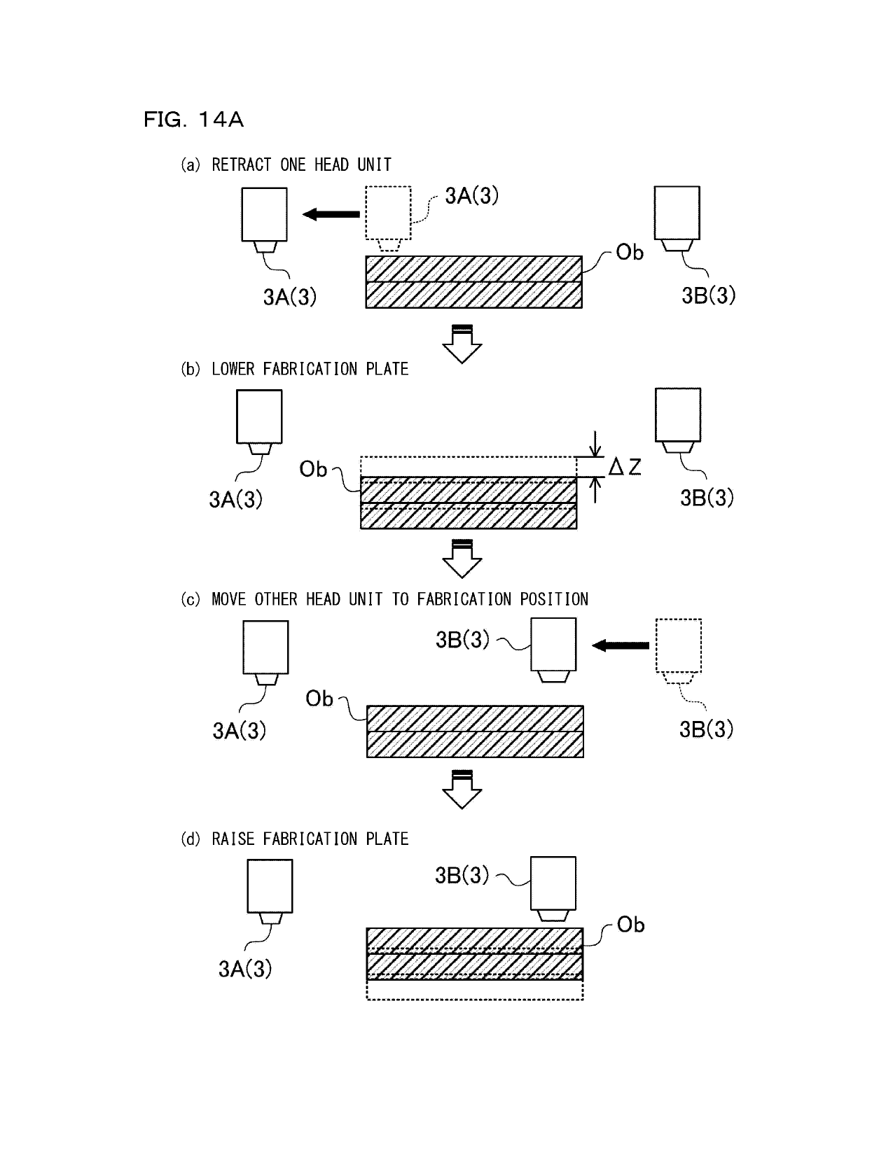

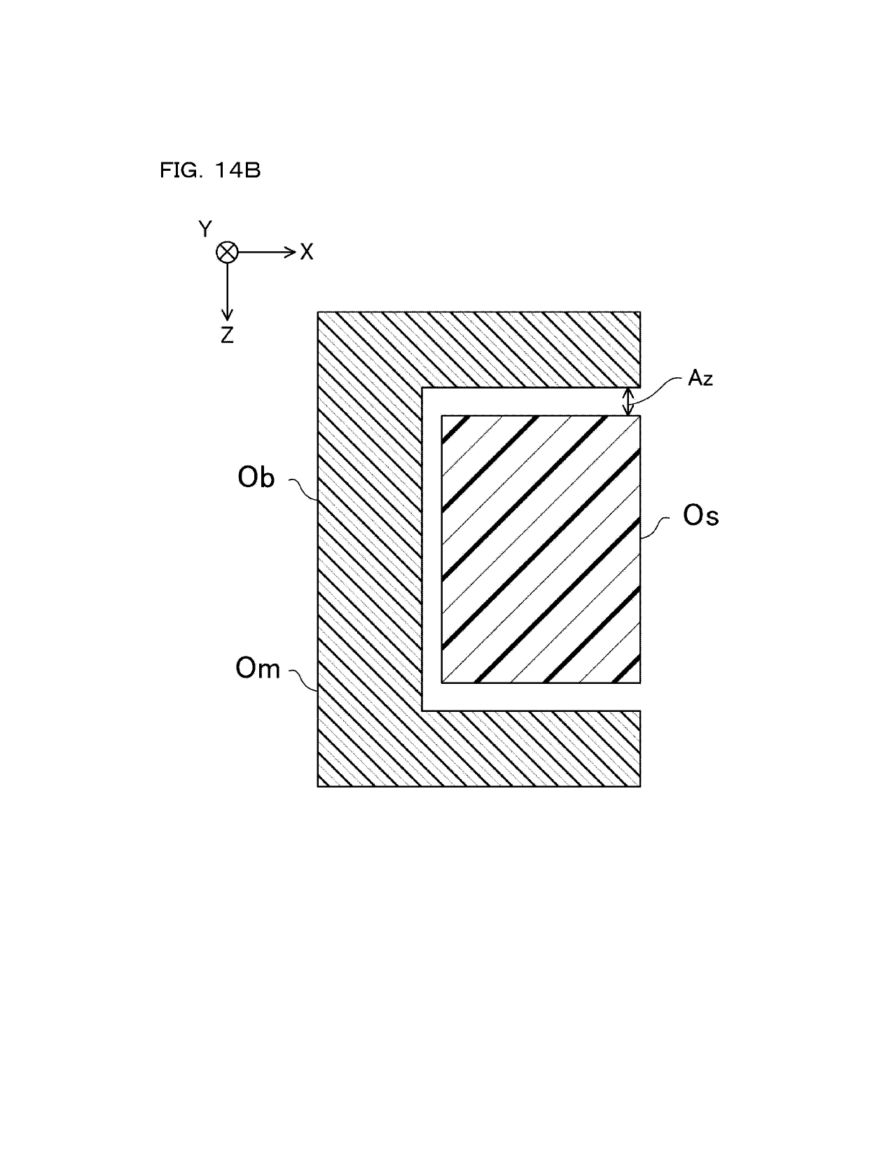

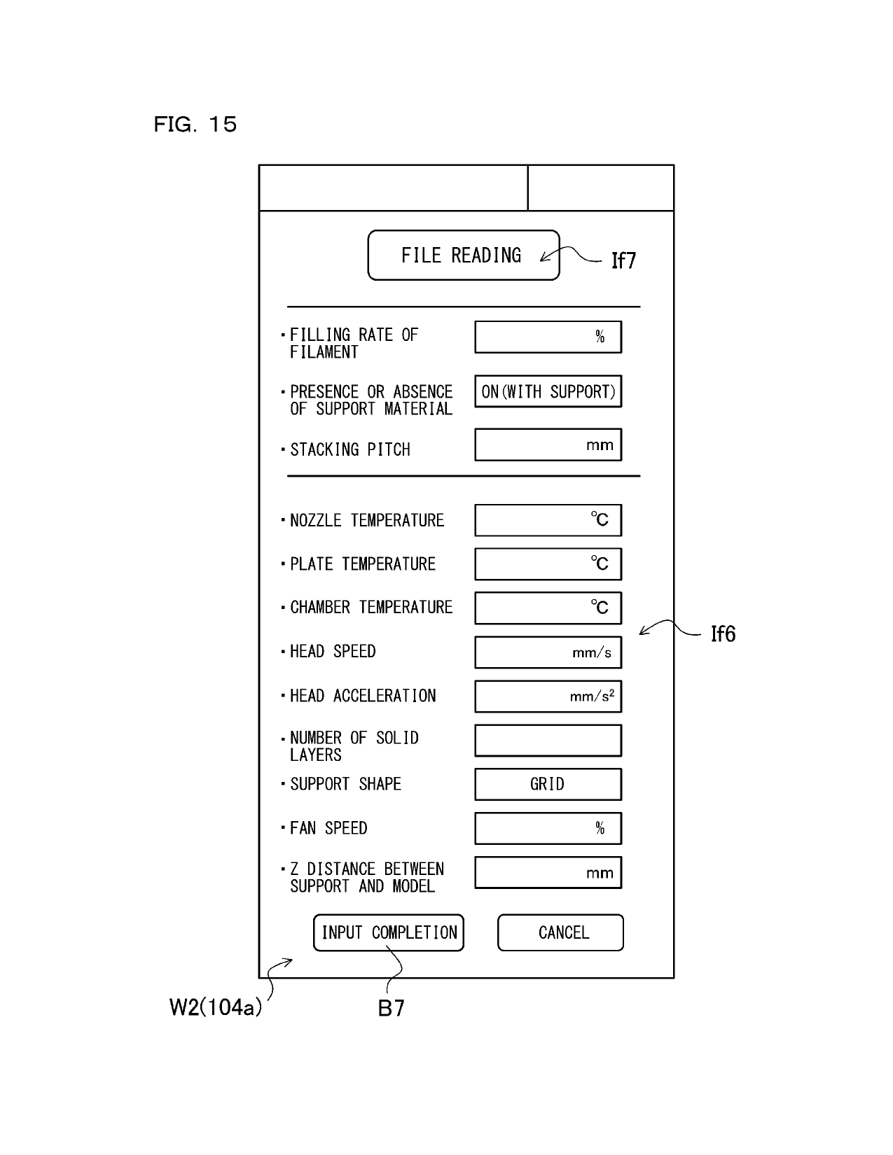

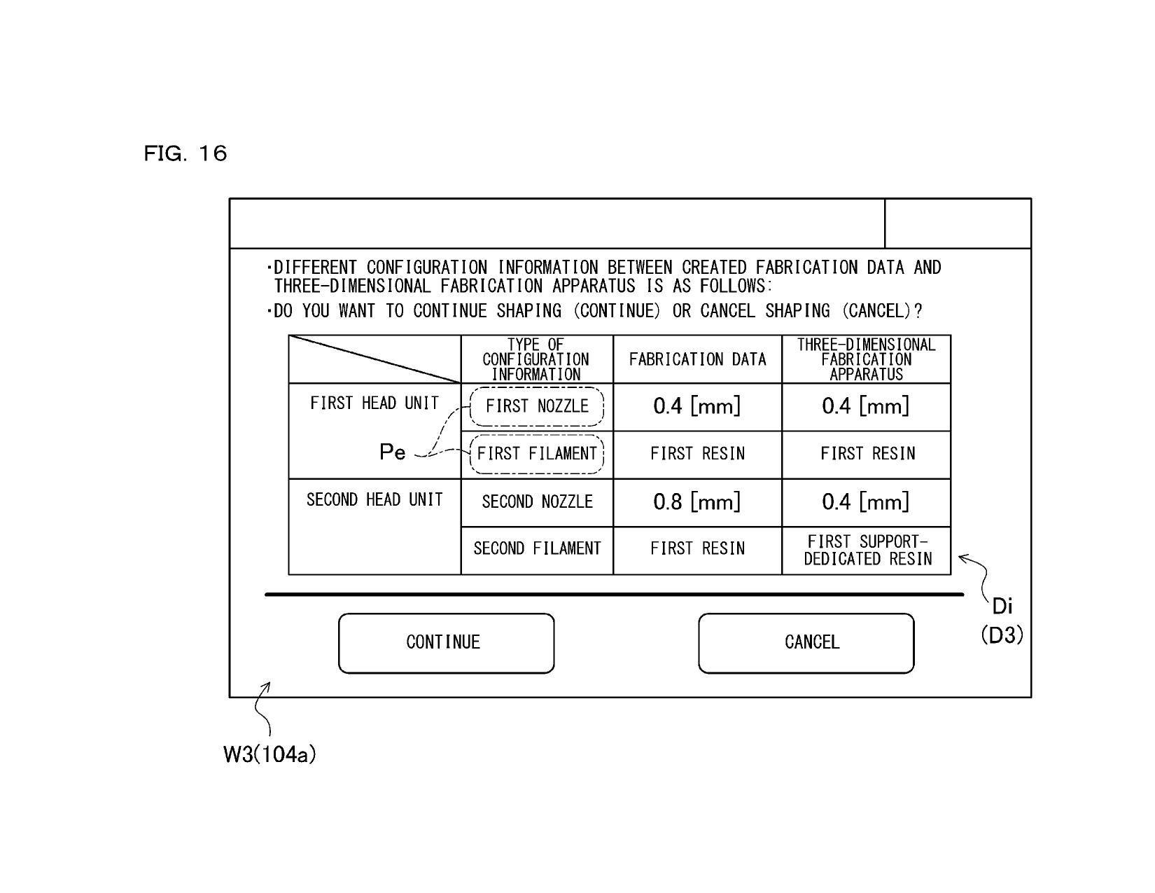

FIGS. 6, 7, and 8 are flowcharts exemplifying a creation procedure of the fabrication data D1. FIGS. 9A and 9B are diagrams for describing a plurality of fabrication modes Mp, respectively. FIG. 10 is a diagram for describing the selection of the fabrication modes Mp. FIG. 11 is a diagram for describing the configuration information data D3. FIG. 12 is a diagram for describing limitations on the types of selectable filaments Fi. FIG. 13 is a diagram for describing fabrication parameters Pt. FIGS. 14A and 14B are diagrams for describing the fabrication parameters Pt. FIG. 15 is a diagram illustrating a dialog W2 for manually inputting the fabrication parameters Pt. Furthermore, FIG. 16 is a diagram illustrating a confirmation screen W3 related to the collation result of the configuration information Di.

First, when the fabrication data creation apparatus A2 is started up and the setting program is activated, the display part 104 displays the display screen 104a as illustrated in FIG. 5. When the display screen 104a is displayed, the fabrication data creation apparatus A2 starts creating the fabrication data D1 (step S101).

Subsequently, before and after the processing from step S103 to step S106 described below, the mode selection section 105c as the mode selection section selects one fabrication mode Mp from the plurality of fabrication modes Mp. This selection can be executed, for example, when the input part 103 receives a manual operation. In the present embodiment, the selection of the fabrication mode Mp is exemplified in FIG. 6 as step S102 executed immediately before step S103.

Here, the plurality of fabrication modes Mp is fabrication modes used by at least one of the plurality of head units 3. As an example, in the present embodiment, the plurality of fabrication modes Mp is used by each of the plurality of head units 3.

The plurality of fabrication modes Mp also corresponds to a plurality of fabrication methods different from each other. One fabrication mode Mp corresponds to one fabrication method. In the present embodiment, five fabrication modes corresponding to five fabrication methods are prepared.

Specifically, as illustrated in FIGS. 9A and 9B, the plurality of fabrication modes Mp according to the present embodiment includes two or more fabrication modes in which the number of head units 3 used for fabricating one three-dimensional fabrication object Ob among the plurality of head units 3 is made different.

Specifically, the plurality of fabrication modes Mp includes a first type fabrication mode M1 illustrated in FIG. 9A and a second type fabrication mode M2 illustrated in FIG. 9B. The first type fabrication mode M1 and the second type fabrication mode M2 each include one or a plurality of different fabrication modes Mp.

The first type fabrication mode M1 is a fabrication mode Mp for controlling one or more (two in the present embodiment) of the plurality of head units 3 to fabricate the same number of three-dimensional fabrication objects Ob as the controlled head units 3.

Specifically, the first type fabrication mode M1 further includes a single fabrication mode M11 in which one three-dimensional fabrication object Ob is fabricated by one head unit 3, and a parallel fabrication mode M12 in which two three-dimensional fabrication objects Ob are fabricated by two head units 3.

The single fabrication mode M11 is a fabrication mode Mp that controls one of the plurality of head units 3 to cause the one head unit 3 to fabricate one three-dimensional fabrication object Ob. As illustrated in FIG. 9A, the single fabrication mode M11 according to the present embodiment may be either of fabricating one three-dimensional fabrication object Ob by the first head unit 3A and fabricating one three-dimensional fabrication object Ob by the second head unit 3B.

The parallel fabrication mode M12 is a fabrication mode Mp that controls two of the plurality of head units 3 to cause the two head units 3 to individually fabricate two three-dimensional fabrication objects Ob.

More specifically, the parallel fabrication mode M12 further includes a dual fabrication mode M121 and a mirror fabrication mode M122. As illustrated in FIG. 9A, the dual fabrication mode M121 is a fabrication mode Mp that simultaneously fabricates two three-dimensional fabrication objects Ob so as to have the same shape. Similarly, as illustrated in FIG. 9A, the mirror fabrication mode M122 is a fabrication mode Mp for simultaneously fabricating two three-dimensional fabrication objects Ob so as to have a three-dimensional shape that is mirror symmetric with each other. Each of the fabrication modes Mp constituting the first type fabrication mode M1 is configured to eject a model material from the nozzle 323.

On the other hand, the second type fabrication mode M2 is a fabrication mode Mp that fabricates one three-dimensional fabrication object Ob by controlling a plurality (two in the present embodiment) of the plurality of head units 3.

Specifically, the second type fabrication mode M2 further includes a speed fabrication mode M21 and a support addition mode M22. Both the speed fabrication mode M21 and the support addition mode M22 are the fabrication mode Mp configured to fabricate one three-dimensional fabrication object Ob by the two head units 3.

The speed fabrication mode M21 is a fabrication mode Mp in which the two head units 3 are controlled to eject the filament Fi used for the model material of the three-dimensional fabrication object Ob from both of the two head units 3.

When focusing on the speed fabrication mode M21, the mode selection section 105c can be regarded as a section that selects any one fabrication mode from the speed fabrication mode M21 and one or a plurality of other fabrication modes Mp in which the operations of the first and second head units 3A and 3B are different from those in the speed fabrication mode M21. The one or the plurality of other fabrication modes Mp includes a support addition mode M22 in addition to the first type fabrication mode M1.

In the speed fabrication mode M21, the model material is ejected from the two head units 3 in order to fabricate one three-dimensional fabrication object Ob. In the speed fabrication mode M21, fabrication can be performed at a higher speed than in the single fabrication mode M11.

In the speed fabrication mode M21, the model material ejected from one of the two head units 3 (for example, the first head unit 3A) fabricates the outer peripheral portion (surface portion) of the three-dimensional fabrication object Ob as illustrated in the first filament layer L1 of FIG. 9B.

In the speed fabrication mode M21, the model material ejected from the other of the two head units 3 (for example, the second head unit 3B) fabricates the infill (inner portion) of the three-dimensional fabrication object Ob as illustrated in the second filament layer L2 of FIG. 9B.

Specifically, the speed fabrication mode M21 according to the present embodiment is a fabrication mode Mp that controls the first and second head units 3A and 3B so that the outer peripheral portion (surface portion) of the three-dimensional fabrication object Ob is fabricated by the first filament F1 ejected from the first head unit 3A, and the infill (inner portion) of the three-dimensional fabrication object Ob is fabricated by the second filament F2 ejected from the second head unit 3B.

Here, the first nozzle outlet 323a from which the model material for fabricating the outer peripheral portion is ejected has a smaller diameter than the second nozzle outlet 323b from which the model material for fabricating the infill is ejected. Since the infill is formed at a coarser stacking pitch than the outer peripheral portion, the fabrication speed is excellent. Since the outer peripheral portion is fabricated at a finer stacking pitch than the infill, the outer peripheral portion is excellent in aesthetics. The speed fabrication mode M21 can quickly fabricate the three-dimensional fabrication object Ob without impairing the aesthetics thereof. Note that the stacking pitch here is a pitch between the first filament layers L1 or a pitch between the second filament layers L2 in the Z direction.

The support addition mode M22 is a fabrication mode Mp in which the filament Fi to be used for the model material of the three-dimensional fabrication object Ob is ejected from one head unit 3 and the filament Fi to be used for the support of the three-dimensional fabrication object Ob is ejected from the other head unit 3 by controlling the two head units 3.

Specifically, the support addition mode M22 according to the present embodiment is a fabrication mode Mp that controls the first and second head units 3A and 3B so that the model portion of the three-dimensional fabrication object Ob is fabricated by the fused filament Fi ejected from one of the hot ends 32 fixed to the first and second head units 3A and 3B. The support addition mode M22 is also a fabrication mode Mp that controls the first and second head units 3A and 3B so that a support portion of the three-dimensional fabrication object Ob is fabricated by another filament Fi ejected from the other of the hot ends 32 fixed to the first and second head units 3A and 3B.

In the support addition mode M22, a dedicated resin for fabricating a support is ejected from the other of the two head units 3 (for example, second head unit 3B), more specifically, the hot end 32 fixed to the head unit 3.

Note that the three-dimensional fabrication object Ob to which the support is added can be fabricated even in the fabrication mode Mp other than the support addition mode M22 such as the single fabrication mode M11. In this case, the support is fabricated with the same resin as the model material. The necessity of the support addition in the fabrication mode Mp other than the support addition mode M22 can be set via a flag indicating the presence or absence of the support in the fabrication parameter Pt.

Returning to step S102 of FIG. 6, the selection of the fabrication mode Mp can be started, for example, by performing a click operation on the first interface If1 in FIG. 5. The first interface If1 is a GUI displayed on the display screen 104a, and can receive a user operation (manual operation) such as a click operation.

As “single fabrication mode” is displayed in FIG. 5, the first interface If1 can also display the current fabrication mode Mp selected by the mode selection section 105c.

When a click operation or the like is performed on the first interface If1, the first window W1 illustrated in FIG. 10 is superimposed and displayed on the display screen 104a. Instead of superimposing and displaying the first window W1, the screen may transition to a screen showing the same contents as the first window W1.

As illustrated in FIG. 10, a plurality of button-shaped interfaces B51 corresponding to each of the plurality of fabrication modes Mp is displayed on the display screen 104a. Each of the plurality of interfaces B51 is a GUI capable of accepting a user operation via the input part 103. When one of the plurality of interfaces B51 receives a user operation, the fabrication mode Mp corresponding to the interface B51 is selected.

As described above, in step S102, the mode selection section 105c selects one of the plurality of fabrication modes Mp by receiving a manual operation of the user via the first window W1 and the input part 103 or by reading a setting file created in advance.

Returning to the flow of FIG. 6, in steps S103 to S106, the parameter setting section 105b sets the type of the replacement member Pe to be replaced by the user in the three-dimensional fabrication apparatus A1. Specifically, the parameter setting section 105b reads the configuration information data D3 indicating the configuration information Di from the storage section 8 of the three-dimensional fabrication apparatus A1 as the configuration storage part. The parameter setting section 105b automatically sets the type of the replacement member Pe included in the read configuration information data D3. The automatically set setting contents are used for creating the fabrication data D1.

Here, the configuration information data D3 is electronic data indicating the configuration information Di of the fabrication module 1. As illustrated in FIG. 11, the configuration information Di indicated by the configuration information data D3 includes the type of the replacement member Pe to be replaced by the user in the three-dimensional fabrication apparatus A1. The replacement member Pe includes, for example, a user-replaceable member in each of the plurality of head units 3.

Specifically, the configuration information Di according to the present embodiment includes the type of the filament Fi as the replacement member Pe. More specifically, the configuration information Di further includes the type of the nozzle 323 that ejects the filament Fi as the replacement member Pe.

As an example, as illustrated in FIG. 11, the configuration information Di according to the present embodiment includes information indicating the type of the first filament F1, information indicating the type of the second filament F2, information indicating the type of the first nozzle 323A, and information indicating the type of the second nozzle 323B.

Specifically, in step S103, the parameter setting section 105b requests the configuration information Di from the three-dimensional fabrication apparatus A1 via the communication part 101 of the fabrication data creation apparatus A2 and the communication part 90 of the three-dimensional fabrication apparatus A1.

In subsequent step S104, the control section 9 of the three-dimensional fabrication apparatus A1 returns the configuration information data D3 from the storage section 8 to the fabrication data creation apparatus A2. The configuration information data D3 includes information indicating the type of the replacement member Pe as described above.

In subsequent step S105, the type selection section 105d selects one type from among the plurality of types of the filament Fi on the basis of the information included in the configuration information data D3 returned from the three-dimensional fabrication apparatus A1.

The type selection executed in step S105 is performed independently for the first filament F1 for the first head unit 3A and the second filament F2 for the second head unit 3B. That is, the type selection section 105d selects one type for the first filament F1 and also selects one type for the second filament F2.

Here, although the type of each filament Fi is not illustrated, in the present embodiment, the filament Fi includes a first resin, a second resin, and a third resin that can be used for both a model material and a support, and a first support-dedicated resin and a second support-dedicated resin that are dedicated to the support.

Furthermore, the type of the filament Fi may be selected on the basis of the manual operation received by the input part 103. For example, after the types of the first filament F1 and the second filament F2 are automatically selected based on the information included in the configuration information data D3, the automatically selected type may be changed based on the manual operation. In that case, the type selection section 105d executes the type selection based on the manual operation after step S106 described later.

At that time, the type selection section 105d according to the present embodiment limits the selectable type among the plurality of types of the filament Fi according to the fabrication mode Mp selected by the mode selection section 105c.

Here, in each cell of the first type fabrication mode M1 of FIG. 12, a check mark is attached to the type of the selectable filament Fi.

As illustrated in FIG. 12, in the case of the first type fabrication mode M1, the type selection section 105d receives the selection of all of the first resin, the second resin, and the third resin.

On the other hand, in each cell of the second type fabrication mode M2 in FIG. 12, for the type of the filament Fi that can be selected by one of the first and second head units 3A and 3B, a check mark is attached to the left side InL of the drawing across the slash symbol. In each cell, for the type of the filament Fi that can be selected by the other of the first and second head units 3A and 3B, a check mark is put on the right side InR of the drawing across the slash symbol.

As illustrated in FIG. 12, in the case of the speed fabrication mode M21 of the second type fabrication mode M2, the type selection section 105d receives the selection of the first resin, the second resin, or the third resin for both the first and second head units 3A and 3B.

Furthermore, as illustrated in FIG. 12, in the case of the support addition mode M22 of the second type fabrication mode M2, the type selection section 105d receives the selection of the first resin, the second resin, or the third resin for one of the first and second head units 3A and 3B, and receives the selection of the first support-dedicated resin or the second support-dedicated resin for the other of the first and second head units 3A and 3B.

Selection of the type by manual operation can be realized, for example, by performing a click operation or the like on the second interface If2 and the third interface If3 in FIG. 5.

The second interface If2 is one GUI displayed on the display screen 104a, and can receive a user operation (manual operation) such as a click operation.

As “first resin” is displayed in FIG. 5, the second interface If2 is selected by the type selection section 105d, and the type of the first filament F1 ejected from the first nozzle outlet 323a of the first head unit 3A can also be displayed.

When a click operation or the like is performed on the second interface If2, a GUI (not illustrated) such as a dialog is displayed on the display screen 104a. By performing a user operation on the GUI, the type of the first filament F1 can be manually selected.

The third interface If3 is one GUI displayed on the display screen 104a, and can receive a user operation (manual operation) such as a click operation.

As “first resin” is displayed in FIG. 5, the third interface If3 is selected by the type

selection section 105d, and the type of the second filament F2 ejected from the second nozzle outlet 323b of the second head unit 3B can also be displayed.

When a click operation or the like is performed on the third interface If3, a GUI (not illustrated) such as a dialog is displayed on the display screen 104a. By performing a user operation on the GUI, the type of the second filament F2 can be manually selected.

In subsequent step S106, the parameter setting section 105b automatically reflects, in the setting information for creating the fabrication data D1, the information included in the configuration information data D3 returned from the three-dimensional fabrication apparatus A1. The information reflected in step S106 includes the type of the resin (filament Fi) selected by the type selection section 105d in step S105.

From subsequent step S107 to step S108, the object disposing section 105a disposes the object 500 acquired by the communication part 101, the connection part 102, or the input part 103 as the acquisition section on the fabrication plane R3 displayed by the display part 104. As illustrated in FIG. 5, the object 500 is a three-dimensional object corresponding to the three-dimensional data Dm.

Specifically, in step S107, the communication part 101, the connection part 102, or the input part 103 as the acquisition section acquires the object 500 corresponding to the three-dimensional data Dm. This process is executed, for example, when the input part 103 receives selection of an STL file (electronic data in the STL format).

Acquisition of the three-dimensional data Dm corresponding to the object 500 can be realized, for example, by performing a click operation or the like on the first button B1 labeled as “file reading” in FIG. 5.

The first button B1 is one GUI displayed on the display screen 104a, and can receive a user operation (manual operation) such as a click operation. By operating the first button B1, the input part 103 can select the STL file.

In subsequent step S108, the object disposing section 105a disposes the object 500 acquired by the communication part 101, the connection part 102, or the input part 103 as the acquisition section on the fabrication plane R3 as illustrated in FIG. 5. The object disposing section 105a sets the arrangement and posture of the object 500 on the fabrication plane R3 on the basis of the operation input received via the input part 103. In addition, the object disposing section 105a can automatically set the arrangement and posture of the object 500 on the fabrication plane R3 without passing through the input part 103.

In subsequent steps S109 to S111, the parameter setting section 105b sets the value of the fabrication parameter Pt of the object 500 disposed by the object disposing section 105a. This setting includes preset processing automatically performed on the basis of the configuration information Di as in step S109 and step S110, and manual setting performed on the basis of a user's manual operation as in step S111.

Here, the fabrication parameter Pt is a set of control target values that characterize the fabrication environment and the fabrication quality of the three-dimensional fabrication object Ob that is actually fabricated. The storage part 106 as a fabrication parameter storage section stores a set (parameter value set D5) of parameter values of the fabrication parameter Pt defined for each fabrication mode Mp and for each type of filament Fi.

In other words, the storage part 106 serving as the fabrication parameter storage section stores, in association with each fabrication mode Mp and each type of the filament Fi used by the at least one head unit 3, a set of values of the fabrication parameter Pt for fabricating the three-dimensional fabrication object Ob using the fabrication method corresponding to the fabrication mode Mp and the filament Fi of each type. The parameter value set D5 indicates a set of such values, and is defined in advance for each fabrication mode Mp and for each type of filament Fi.

Here, as illustrated in FIG. 13, the control target value constituting the fabrication parameter Pt includes at least the filling rate of the filament Fi in the three-dimensional fabrication object Ob, a flag indicating the presence or absence of support in the three-dimensional fabrication object Ob, and the stacking pitch in the three-dimensional fabrication object Ob. These fabrication parameters Pt are displayed on the display screen 104a as main parameters (see the fourth interface If4 in FIG. 5). The parameter setting section 105b can receive a change in the main fabrication parameter Pt via the fourth interface If4.

In addition, the control target value constituting the fabrication parameter Pt includes the nozzle temperature, the plate temperature, the chamber temperature, the head speed, the head acceleration, the number of solid layers, the support shape, the fan speed, the distance between the support and the model, the Z hop, the stacking pitch of the infill when fabricating the three-dimensional fabrication object Ob, the line width (top layer) of the filament Fi extruded by the fabrication plate 21, and the line width (other than the top layer) as well. The fabrication parameters Pt may include at least one of these parameters.

Here, the nozzle temperature indicates a temperature of the nozzle 323. The plate temperature indicates a temperature of the fabrication plate 21. The chamber temperature indicates an internal temperature of the chamber 5. The head speed indicates a moving speed of each head unit 3 in the XY direction. The head acceleration indicates an acceleration of each head unit 3. The support shape indicates a shape of the support such as a grid. The number of solid layers indicates a number of solid layers. The solid layer indicates a layer having a filling rate of 100% existing in the top layer and the bottom layer in the three-dimensional fabrication object Ob. The support shape indicates a fabrication pattern of the support portion. The fan speed indicates an air volume, a wind speed, or a drive load of the chamber fan 62.

The Z distance between the support and the model indicates a distance between the support and the model in the Z direction in the support addition mode M22. Specifically, the distance between the support and the model here indicates a gap in the Z direction between the model portion Om and the support portion Os in the three-dimensional fabrication object Ob, as exemplified by a double-headed arrow Az in FIG. 14B.

Furthermore, as illustrated with a reference sign ΔZ in FIG. 14A, Z hop indicates a lowering amount when lowering the fabrication plate 21 in the Z direction (temporarily) at the time of switching from the fabrication by one of the two head units 3 to the fabrication by the other. In relation to this lowering amount (Z hop), the process of lowering the fabrication plate 21 in the Z direction temporarily when switching from the fabrication by one of the two head units 3 to the fabrication by the other is referred to as “Z-hop processing”.

As an example, a description will be given of the Z hop when the stacking of the first filament layer L1 by one of the two head units 3, for example, the first head unit 3A is completed, and switching to the stacking of the second filament layer L2 by the other of the two head units 3, for example, the second head unit 3B. The description here is common to the stacking of the infills and the stacking of the outer peripheral portions.

When the stacking of the first filament layer L1 by the first head unit 3A is completed, as illustrated in (a) of FIG. 14A, the first head unit 3A is retracted from the fabrication position located immediately above the three-dimensional fabrication object Ob being fabricated to the retraction position displaced in the XY direction with respect to the fabrication position.

Subsequently, although it is conceivable to move the second head unit 3B to the fabrication position, there is a possibility that the filament Fi leaking from the second head unit 3B adheres to the three-dimensional fabrication object Ob being fabricated simply by moving the second head unit 3B.

Therefore, before moving the second head unit 3B to the fabrication position, the fabrication plate 21, and thus the three-dimensional fabrication object Ob on the fabrication plate 21 are lowered along the Z direction as illustrated in (b) of FIG. 14A. The lowering amount ΔZ at that time is the Z hop constituting the fabrication parameter Pt.

Then, as illustrated in (c) of FIG. 14A, the second head unit 3B is moved to the fabrication position located immediately above the three-dimensional fabrication object Ob being fabricated while lowering the three-dimensional fabrication object Ob via the fabrication plate 21. The attachment of the filament Fi is avoided by lowering the fabrication plate 21 in the above (b).

Then, as illustrated in (d) of FIG. 14A, after the three-dimensional fabrication object Ob is raised through the fabrication plate 21, the fabrication by the second head unit 3B is started.

Furthermore, in FIG. 13, an item “change according to the filament type” arranged on the side of each fabrication parameter Pt arranged from the middle stage to the lower stage of the page indicates whether or not the value of the fabrication parameter Pt adjacent to the item changes according to each type of the filament Fi selected by the type selection section 105d. This indicates that the fabrication parameter Pt adjacent to the item marked with a check mark can change according to the type of the filament Fi.

In the case of the example of FIG. 13, the nozzle temperature, the plate temperature, the chamber temperature, the head speed, the fan speed, the Z distance between the support and the model, and the Z hop correspond to the fabrication parameters Pt that can change according to the type of the filament Fi.

For example, depending on the melting point of the filament Fi, the optimal nozzle temperature, plate temperature and chamber temperature, and fan speed may vary. Furthermore, the optimum head speed may also vary depending on the fusion situation corresponding to the melting point of the filament Fi.

On the other hand, in FIG. 13, the item “change according to fabrication mode” disposed on the further side of the “change according to the filament type” indicates whether or not the values of the adjacent fabrication parameters Pt change across the “change according to the filament type” according to the fabrication mode Mp selected by the mode selection section 105c. This indicates that the fabrication parameter Pt adjacent to the item marked with a check mark can change according to the type of the fabrication mode Mp.

In the case of the example of FIG. 13, the Z distance between the support and the model, the Z hop, the stacking pitch of the infill, the line width (top layer), and the line width (other than the top layer) correspond to the fabrication parameter Pt that can change according to the fabrication mode Mp.

Here, the parameter setting section 105b according to the present embodiment automatically sets the value of the fabrication parameter Pt according to the number of head units 3 used for the fabrication of one three-dimensional fabrication object Ob based on the fabrication mode selected by the mode selection section 105c.

In other words, this setting corresponds to whether the fabrication mode Mp is the first type fabrication mode M1 or the second type fabrication mode M2. For example, the Z hop is not set or set to zero in the first type fabrication mode M1, and is set to a non-zero value in the second type fabrication mode M2.

Furthermore, the parameter setting section 105b according to the present embodiment is configured to make the value of the fabrication parameter Pt common between the case where the fabrication mode Mp selected by the mode selection section 105c belongs to the single fabrication mode M11 and the case where the fabrication mode Mp belongs to the parallel fabrication mode M12.

In other words, the parameter setting section 105b sets the fabrication parameters Pt to be the same in the single fabrication mode M11 and the parallel fabrication mode M12 when the type of the filament Fi is the same even in the fabrication parameters Pt checked in FIG. 13.

Furthermore, the parameter setting section 105b according to the present embodiment is configured to make the value of at least some of the fabrication parameters Pt different between the case where the fabrication mode Mp selected by the mode selection section 105c belongs to the speed fabrication mode M21 and the case where the fabrication mode Mp belongs to the support addition mode M22.

For example, the stacking pitch of the infill in the speed fabrication mode M21 is larger than the stacking pitch of the infill in the other fabrication modes Mp.

In addition, as the line widths (other than the top layer), for example, in the case of the speed fabrication mode M21, line widths corresponding to different nozzle outlets 323a and 323b, and eventually, line widths corresponding to the nozzle diameters are used for the outer peripheral portion fabricated by the first nozzle 323A and the infill portion fabricated by the second nozzle 323B. The use of such line widths is processing that is not performed in the other fabrication modes Mp.

On the other hand, when fabricating the top layer, even in a case where the speed fabrication mode M21 is selected, the first nozzle 323A having a relatively small diameter is used as in the other fabrication modes Mp. Therefore, the line width (top layer) is the same regardless of the selection of the fabrication mode Mp.

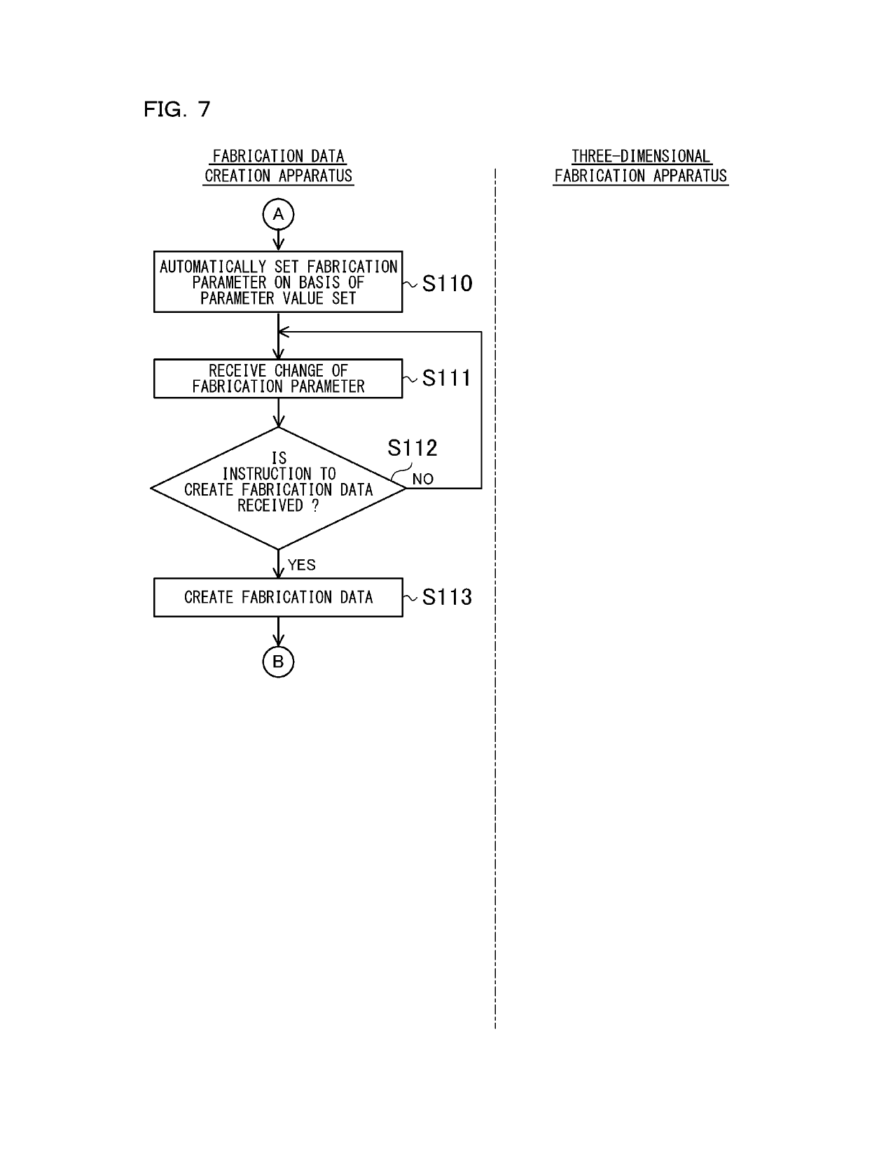

Returning to the flow of FIG. 7, in step S109, the parameter setting section 105b collates the fabrication mode Mp selected by the mode selection section 105c and the type of the filament Fi selected by the type selection section 105d with the parameter value set D5 stored in the storage part 106.

Subsequently, in step S110 of FIG. 7 following step S109 of FIG. 6, the parameter setting section 105b automatically sets the value of the fabrication parameter Pt according to the fabrication mode Mp selected by the mode selection section 105c and the type selected by the type selection section 105d. This setting is executed on the basis of the parameter value set D5 stored in the storage part 106. Thus, the value of the fabrication parameter Pt selected in advance by the manufacturer is automatically preset. By this preset, the fabrication parameters Pt corresponding to both the fabrication mode Mp and the type of the filament Fi are set.

In subsequent step S111, the parameter setting section 105b accepts a change in the value of the preset fabrication parameter Pt. This change is executed via the input part 103.

Note that for example, the parameter setting section 105b according to the present embodiment can manually input the filling rate of the filament Fi in the three-dimensional fabrication object Ob, the flag ("ON" or "OFF”) indicating the presence or absence of support in the three-dimensional fabrication object Ob, and the stacking pitch in the three-dimensional fabrication object Ob via the above-described fourth interface If4.

Furthermore, the parameter setting section 105b can manually input the value of each fabrication parameter Pt through the dialog W2 as illustrated in FIG. 15 for the fabrication parameter Pt other than the main parameter such as the nozzle temperature. The dialog W2 is a GUI that the parameter setting section 105b displays on the display screen 104a via the display part 104.

In the dialog W2 of FIG. 15, the parameter setting section 105b may receive the value of each fabrication parameter Pt via a sixth interface If6 that receives manual input of each fabrication parameter Pt, or may receive the value of each fabrication parameter Pt via a seventh interface If7 that reads a setting file in which the value of each fabrication parameter Pt is described. Note that, in the present embodiment, only a setting file for a predetermined specific filament can be read. Thus, an unexpected setting file is not read, and the three-dimensional fabrication system S can be appropriately operated.

Here, the sixth interface If6 is a GUI that is provided for each type of fabrication parameter Pt and can receive manual input of a value of each fabrication parameter Pt.

In subsequent step S112, the fabrication data creation section 105e determines whether or not an operation input to a generation button B2 on the display screen 104a has been received via the input part 103. This determination can be rephrased as “whether or not an instruction to create the fabrication data D1 has been received”. The generation button B2 to be determined includes, for example, a GUI to which words such as “data generation”, “slice generation”, and “slice data generation” are attached and which can accept an operation input for instructing the creation of the fabrication data D1.

In a case where the determination in step S112 is NO, the fabrication data creation section 105e returns the control process to step S111. In a case where the determination in step S112 is YES, the fabrication data creation section 105e advances the control process to step S113.

In subsequent step S113, the fabrication data creation section 105e creates the fabrication data D1 for fabricating the three-dimensional fabrication object Ob corresponding to the object 500 disposed by the object disposing section 105a.

The fabrication data D1 is fabrication data for fabricating the three-dimensional fabrication object Ob, and includes a trajectory (path) assigned to each of the first hot end 32A and the second hot end 32B. The created fabrication data D1 is transferred to the three-dimensional fabrication apparatus A1 and then stored in the storage section 8.

Here, the fabrication data creation section 105e according to the present embodiment is configured to create the fabrication data D1 on the basis of the fabrication mode Mp selected by the mode selection section 105c.

Specifically, the fabrication data creation section 105e executes the creation of the fabrication data D1 on the basis of the value of the fabrication parameter Pt set by the parameter setting section 105b. The value of the fabrication parameter Pt is set on the basis of the fabrication mode Mp selected by the mode selection section 105c. As a result, the fabrication data creation section 105e according to the present embodiment eventually creates the fabrication data D1 on the basis of the fabrication mode Mp selected by the mode selection section 105c.

Here, the fabrication data D1 includes a command to designate the trajectory of the nozzle 323 for generating the filament layers L1 and L2 after slicing the object 500 into the plurality of filament layers L1 and L2 arranged in the Z direction. The trajectory of the nozzle 323 can be individually set by the first nozzle 323A or the first hot end 32A to which the first nozzle 323A is fixed and the second nozzle 323B or the second hot end 32B to which the second nozzle 323B is fixed. The trajectory of the nozzle 323 can be set by designating a target position (in particular, the target position on the XY plane) of each of the first nozzle 323A and the second nozzle 323B.

That is, the fabrication data D1 includes a command that is input to the X-axis drive part 33 and the Y-axis drive part 42 via the control section 9 and indicates a target position to be realized by each nozzle 323.

The fabrication data creation section 105e, for example, slices the three-dimensional data Dm at a plurality of Z positions, and determines the target position on the basis of the intersection of the slice plane and each facet constituting the three-dimensional data Dm. That is, the fabrication data creation section 105e may generate the fabrication data D1 with reference to the three-dimensional data Dm in addition to the fabrication parameter Pt set by the parameter setting section 105b.

In addition, the fabrication data D1 includes a command input to each part of the three-dimensional fabrication apparatus A1 so as to realize each control target value constituting the fabrication parameter Pt. For example, the fabrication data D1 includes a command that is input to the nozzle heater 321 via the control section 9 and indicates a target value of the nozzle temperature to be realized by the nozzle heater 321.

Furthermore, the fabrication data D1 includes at least information that can specify the type of the replacement member Pe in the configuration information Di, and various types of information (additional information) attached to the fabrication data D1. The latter additional information includes, for example, a data name (job name) of the fabrication data D1, a creator name (owner name), and an estimated predicted fabrication time.

Specifically, in step S113, the fabrication data creation section 105e executes the creation of the fabrication data D1 triggered by the operation input in step S112. The creation of the fabrication data D1 is executed on the basis of the form of the object 500 disposed by the object disposing section 105a and the value of the fabrication parameter Pt set by the parameter setting section 105b as described above.

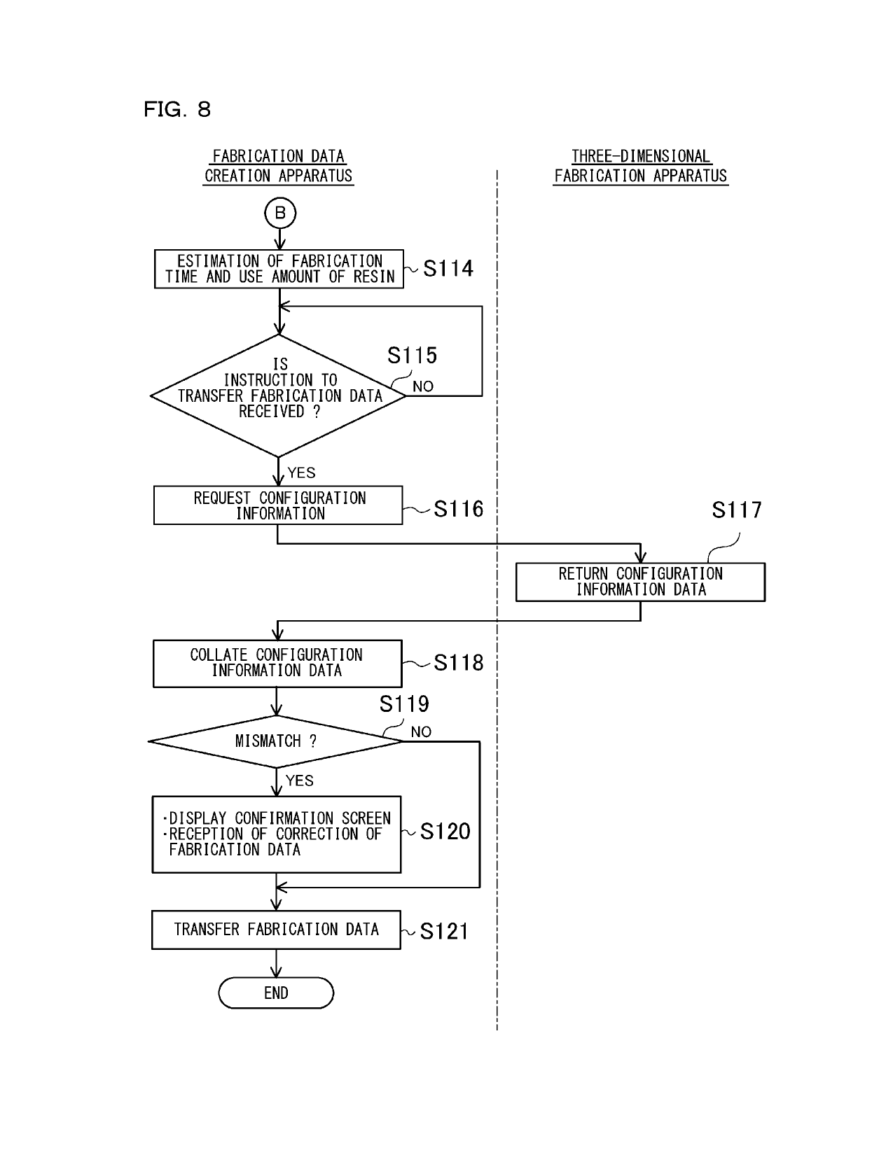

Subsequently, in step S114 of FIG. 8 following step S113 of FIG. 7, the estimation section 105f estimates the fabrication time required for the fabrication of the three-dimensional fabrication object Ob and the use amount of resin required for the fabrication on the basis of the fabrication data D1 created in step S113. This estimation can be started by a user operation on an estimate button B3 on the display screen 104a illustrated in FIG. 5. In the same step S114, the estimation section 105f displays the estimated fabrication time on the display screen 104a (see the fifth interface If5 in FIG. 5).

In subsequent step S115, the fabrication data transfer section 105g determines whether or not an operation input to the transfer button B4 on the display screen 104a has been received via the input part 103. The transfer button B4 to be determined includes, for example, a GUI that can receive an operation input for instructing transfer of the fabrication data D1 to which words such as “transfer” and “data transfer” are attached.

In a case where the determination in step S115 is NO, the fabrication data transfer section 105g returns the control process to step S115. In a case where the determination in step S115 is YES, the fabrication data transfer section 105g advances the control process to step S116.

In subsequent step S116, the parameter setting section 105b requests the configuration information Di from the three-dimensional fabrication apparatus A1 via the communication part 101 of the fabrication data creation apparatus A2 and the communication part 90 of the three-dimensional fabrication apparatus A1.

In subsequent step S117, the control section 9 of the three-dimensional fabrication apparatus A1 returns the configuration information data D3 from the storage section 8 to the fabrication data creation apparatus A2. The configuration information data D3 includes information indicating the type of the replacement member Pe as described above.

In subsequent step S118, the parameter setting section 105b collates the configuration information data D3 returned in step S104 with the configuration information data D3 returned in step S117.

In subsequent step S119, the parameter setting section 105b determines whether or not the configuration information data D3 returned in step S117 does not match the configuration information data D3 returned in step S104, that is, the configuration information data D3 included in the fabrication data D1.

Specifically, in step S119, the parameter setting section 105b determines whether or not the type of the replacement member Pe included in the fabrication data D1 and the type of the replacement member Pe included in the configuration information data D3 returned in step S117 do not match.

In a case where the determination in step S119 is NO (in a case of match), the parameter setting section 105b skips the subsequent step S120 and advances the control process to step S121.

On the other hand, when the determination in step S119 is YES (in a case of mismatch), the parameter setting section 105b advances the control process to step S120. In this case, the parameter setting section 105b causes the display part 104 to display a confirmation screen W3 for allowing the user to confirm selection of necessity of correction for the configuration information Di.

More specifically, before the transfer of the fabrication data D1 in step S121 described later, the parameter setting section 105b causes the display part 104 to display a confirmation screen W3 for allowing the user to confirm selection of necessity of correction for the configuration information Di (see FIG. 16). On the confirmation screen W3, a GUI (“continue”) pressed in the case of transferring the fabrication data D1 without correcting the configuration information Di and a GUI (“cancel”) pressed in the case of correcting the value of the fabrication parameter Pt are displayed.

The confirmation screen W3 illustrated in FIG. 16 is a diagram illustrating the type of the replacement member Pe included in the fabrication data D1 and the type of the replacement member Pe included in the configuration information data D3 returned in step S117 side by side.

In a case where correction of the configuration information Di in the fabrication data D1, such as information indicating the type of the nozzle 323 and the filament Fi, is necessary, the parameter setting section 105b receives the correction, and then returns the control process to step S109, S112, or step S113. For example, in a case where the control process returns to step S109, the parameter setting section 105b resets the fabrication parameter Pt on the basis of the corrected configuration information Di. On the other hand, in a case where it is not necessary to correct the configuration information Di, the parameter setting section 105b advances the control process to step S121.

Thereafter, in step S121, the communication part 101 as an output section transfers the fabrication data D1 to the three-dimensional fabrication apparatus A1. The three-dimensional fabrication apparatus A1 to which the fabrication data D1 has been transferred starts processing related to the fabrication of the three-dimensional fabrication object Ob corresponding to the fabrication data D1.

That is, in step S121, the communication part 101 as an output section outputs the fabrication data D1 to the three-dimensional fabrication apparatus so as to operate the first hot end 32A and the second hot end 32B according to the fabrication data D1 created by the fabrication data creation section 105e.

### 5. Creation example of fabrication data D1

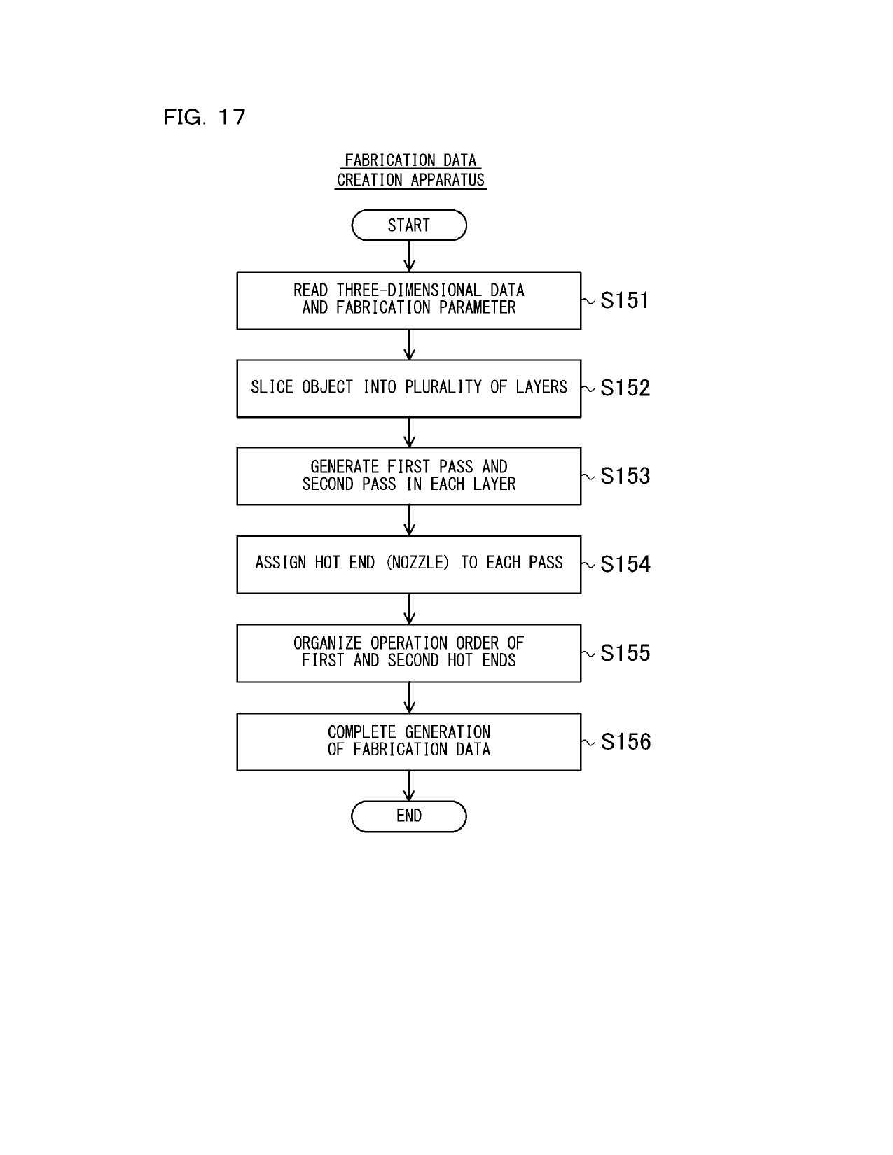

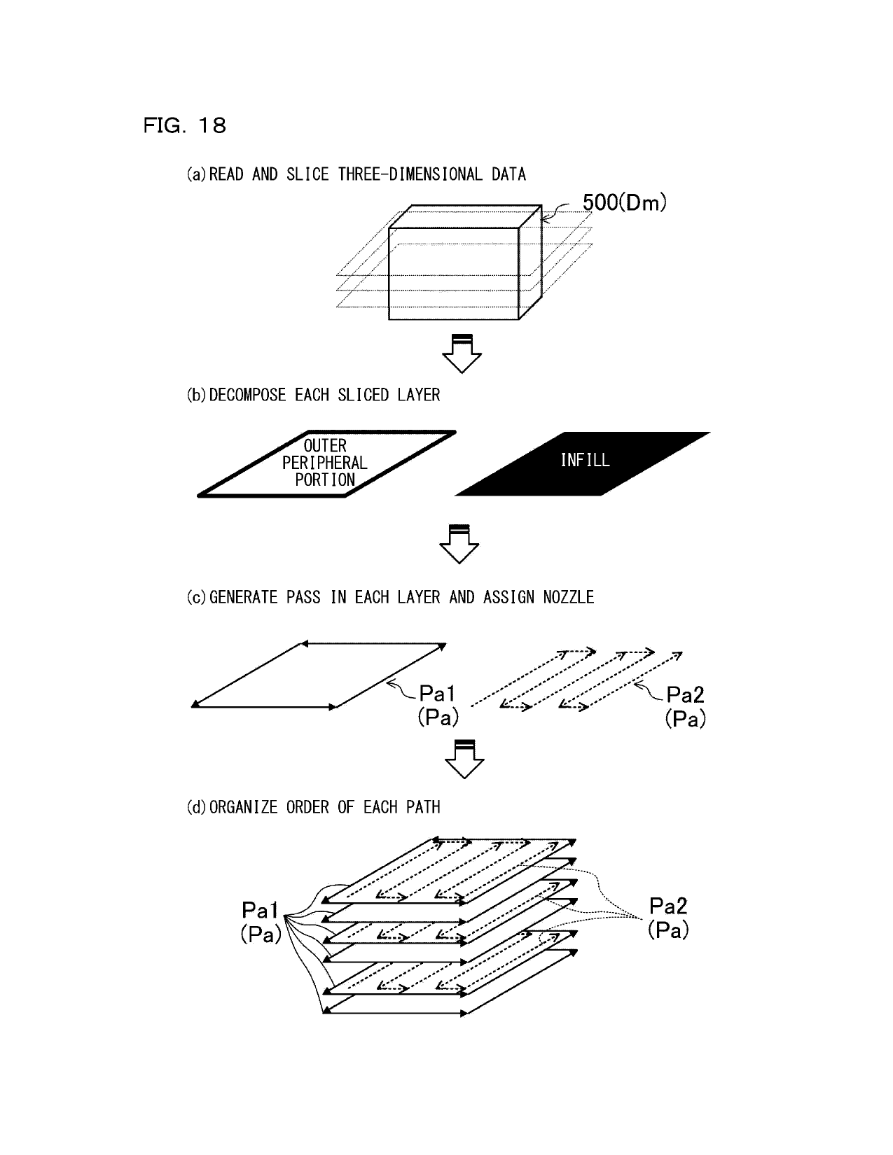

FIG. 17 is a flowchart illustrating a creation procedure of the fabrication data D1. FIG. 18 is a diagram for describing each path Pa constituting the fabrication data D1. First, in step S151 of FIG. 17, the fabrication data creation section 105e reads the three-dimensional data Dm and the fabrication parameter Pt from the storage part 106 or the like of the fabrication data creation apparatus A2.

In subsequent step S152, the fabrication data creation section 105e slices the object 500 corresponding to the three-dimensional data Dm into a plurality of layers arranged in the Z direction (see also FIG. 18(a)). The interval between the layers in the Z direction is defined by, for example, the stacking pitch described above.

In subsequent step S153, the fabrication data creation section 105e decomposes each layer arranged in the Z direction into a surface portion (outer peripheral portion) and an inner portion (infill), and generates a path Pa corresponding to both the decomposed portions (see also FIG. 18(b) and (c)). This path Pa is nothing but a "trajectory" to be followed by each nozzle 323. The path Pa is generated for each of the plurality of layers arranged in the Z direction.

Hereinafter, the path Pa corresponding to the surface portion is referred to as a first path Pa1, and the path Pa corresponding to the inner portion is referred to as a second path Pa2.

In subsequent step S154, the fabrication data creation section 105e assigns one or both of the two hot ends 32 to each of the first path Pa1 corresponding to the surface portion and the second path Pa2 corresponding to the inner portion based on the fabrication mode Mp selected by the mode selection section 105c.

For example, in the case of the support addition mode M22 of the first type fabrication mode M1 and the second type fabrication mode M2, one hot end 32 is assigned to both the first path Pa1 and the second path Pa2.

On the other hand, in the case of the speed fabrication mode M21 of the second type fabrication mode M2, separate hot ends 32 are assigned to the first path Pa1 and the second path Pa2.

Specifically, in the case of the speed fabrication mode M21, the fabrication data creation section 105e assigns the first hot end 32A including the first nozzle outlet 323a having a small diameter to the first path Pa1, and assigns the second hot end 32B including the second nozzle outlet 323b having a large diameter to the second path Pa2. A similar assignment is performed for the path Pa of each layer arranged in the Z direction.

In subsequent step S155, the fabrication data creation section 105e arranges the first path Pa1 and the second path Pa2 in order from the Z position close to the fabrication plate 21 to organize the operation order of the first hot end 32A and the second hot end 32B (see also FIG. 18(d)). The control section 9 controls the trajectory of the first hot end 32A and the second hot end 32B according to this arrangement order.

At this time, the first path Pa1 is arranged for all the layers arranged in the Z direction, and the second path Pa2 is arranged not for all the layers arranged in the Z direction, but by skipping one layer (every other layer) or by skipping two layers (every two layers). The interval (how many layers are arranged) of the second paths Pa2 in the Z direction is defined by, for example, the “stacking pitch of the infill” described above.

Thereafter, in step S156, various control target values such as the target temperature of the nozzle temperature are integrated with the information indicating each path Pa arranged in step S154, and the generation of the fabrication data D1 is completed. The generated fabrication data D1 is stored in the storage section 8 and then transferred to the three-dimensional fabrication apparatus A1. The collation at the time of transfer is as described with reference to step S118 and the like.

Thus, the fabrication data D1 according to the present embodiment includes the first path Pa1 and the second path Pa2 (Specifically, information indicating each path Pa is included.) defined as described above in a plurality of layers in which the object 500 corresponding to the three-dimensional data Dm of the three-dimensional fabrication object Ob is sliced in the Z direction. Then, the control section 9 controls the first head unit 3A on the basis of the first path Pa1, and controls the second head unit 3B on the basis of the second path Pa2.

### 6. Fabrication procedure of three-dimensional fabrication object Ob

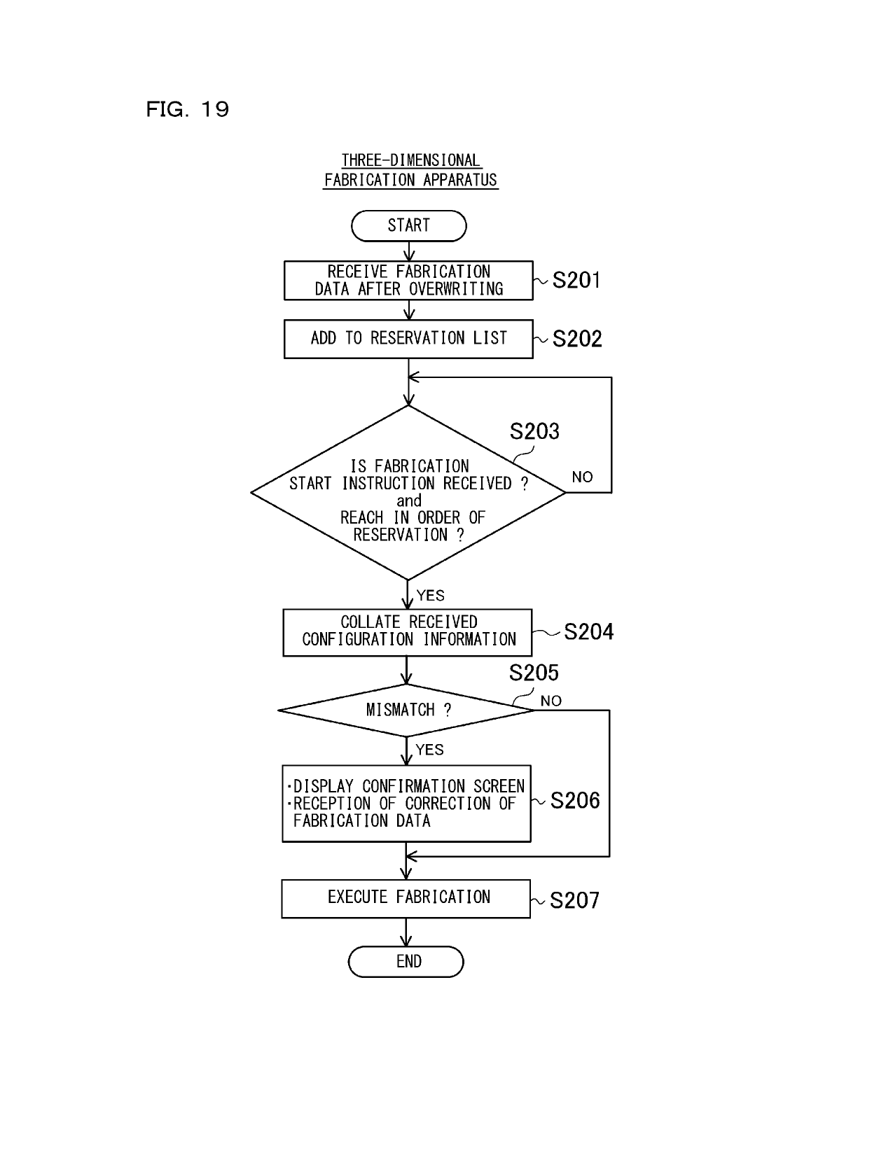

FIG. 19 is a flowchart illustrating a fabrication procedure of the three-dimensional fabrication object Ob. First, in step S201 in the drawing, the three-dimensional fabrication apparatus A1 acquires (receives) fabrication data D1 via the communication part 90.

In subsequent step S202, the control section 9 adds the fabrication data D1 acquired in step S201 to a reservation list in the order of acquisition. Although not illustrated, this reservation list is stored in the storage section 8 of the three-dimensional fabrication apparatus A1, and various fabrication data D1 created by one or a plurality of users are arranged in the order of acquisition in the three-dimensional fabrication apparatus A1.

In subsequent step S203, the control section 9 determines whether or not an instruction to start fabrication for the fabrication data D1 acquired in step S201 has been received. This determination can be executed through a user operation on a fabrication start button B5 in FIG. 5 in the fabrication data creation apparatus A2 or a touch panel GUI displayed on the interface part 7 for instructing the fabrication start. Note that the fabrication start button B5 of FIG. 5 may be provided in the housing 51 of the fabrication module 1. That is, the fabrication may be started when the user presses the fabrication start button B5 displayed on the housing 51.

In step S203, it is further determined whether or not the fabrication data D1 acquired in step S201 has reached in the order of reservation on the basis of the reservation list set in step S202.

In a case where one of the two types of determination in step S203 is NO, the control section 9 returns the control process to step S203. In a case where the two determinations in step S203 are both YES, the control section 9 advances the control process to step S204.

In subsequent step S204, the control section 9 collates the configuration information Di included in the fabrication data D1 received in step S201, for example, information indicating the type of the replacement member Pe with the configuration information data D3 stored in the storage section 8 of the three-dimensional fabrication apparatus A1 itself.

In subsequent step S204, the control section 9 determines whether or not the configuration information Di included in the fabrication data D1 received in step S201 and the configuration information Di included in the configuration information data D3 stored in the storage section 8 of the three-dimensional fabrication apparatus A1 itself do not match.

Specifically, in step S204, the control section 9 determines whether or not the type of the replacement member Pe included in the received fabrication data D1 and the type of the replacement member Pe stored in the storage section 8 do not match.

In a case where the determination in step S204 is NO (in a case of match), the control section 9 skips the subsequent step S206 and advances the control process to step S207.

On the other hand, in a case where the determination in step S204 is YES (in a case of mismatch), the control section 9 advances the control process to step S206. In this case, the control section 9 causes the interface part 7 to display a confirmation screen (not illustrated) for causing the user to confirm selection of necessity of correction for the configuration information Di in the fabrication data D1 set by the three-dimensional fabrication apparatus A1, similarly to the process related to FIG. 19.

In a case where correction of the configuration information Di in the fabrication data D1, such as information indicating the type of the nozzle 323 and the filament Fi, is necessary, the control section 9 receives the correction and then advances the control process to step S207. On the other hand, in a case where it is not necessary to correct the configuration information Di, the control section 9 advances the control process to step S207 without receiving the correction of the configuration information Di. The correction to the fabrication data D1 may be performed by the control section 9 via the interface part 7, or may be performed by a remote operation from the fabrication data creation apparatus A2.

Specifically, as exemplified in step S202 and the like, even if the fabrication data D1 is transferred from the fabrication data creation apparatus A2 to the three-dimensional fabrication apparatus A1, the fabrication data D1 is temporarily added to the reservation list. Depending on the reservation, a significant time difference occurs between the processing of step S202 and the processing of step S203.

The configuration information Di in the currently reserved fabrication data D1 in advance is not necessarily the same as the configuration information Di in the fabrication data D1 transferred by another user. For example, there is a possibility that fabrication in different fabrication modes Mp is mixed in the reservation list. In this case, the types of the second filament F2 and the second nozzle 323B may also change.

In other words, the configuration information Di referred to at the time of creating the fabrication data D1 and the actual configuration information Di in the three-dimensional fabrication apparatus A1 are not necessarily the same. In a case where the configuration information Di has changed, it is necessary to correct the fabrication data D1 so as to follow the change.

On the other hand, by configuring to execute confirmation and correction of the fabrication data D1 immediately before the fabrication, the fabrication data D1 can be adjusted so as to follow the change in the configuration information Di. Such a configuration is particularly effective in a usage situation in which the reservation list is utilized, for example, a situation in which one three-dimensional fabrication apparatus A1 is used by a plurality of users.

In step S207 following step S206, the control section 9 executes the fabrication of the three-dimensional fabrication object Ob according to each command defined in the fabrication data D1. Thus, the three-dimensional fabrication object Ob based on the fabrication parameter Pt set by the parameter setting section 105b and the fabrication data D1 created by the fabrication data creation section 105e on the basis of the fabrication parameter Pt is fabricated.

For example, in a case where the speed fabrication mode M21 is selected from the plurality of fabrication modes Mp, the control section 9 as the control part controls the first head unit 3A so that the surface portion of the three-dimensional fabrication object Ob is fabricated by the fused first filament F1 ejected from the first hot end 32A based on the fabrication data D1 stored in the storage section 8. In addition to the control, the control section 9 also controls the second head unit 3B so that the infill (inner portion) of the three-dimensional fabrication object Ob is fabricated by the fused second filament F2 ejected from the second hot end 32B.

### 7. Specific example of fabrication procedure in speed fabrication mode M21

Hereinafter, the fabrication procedure in the speed fabrication mode M21 will be specifically exemplified.

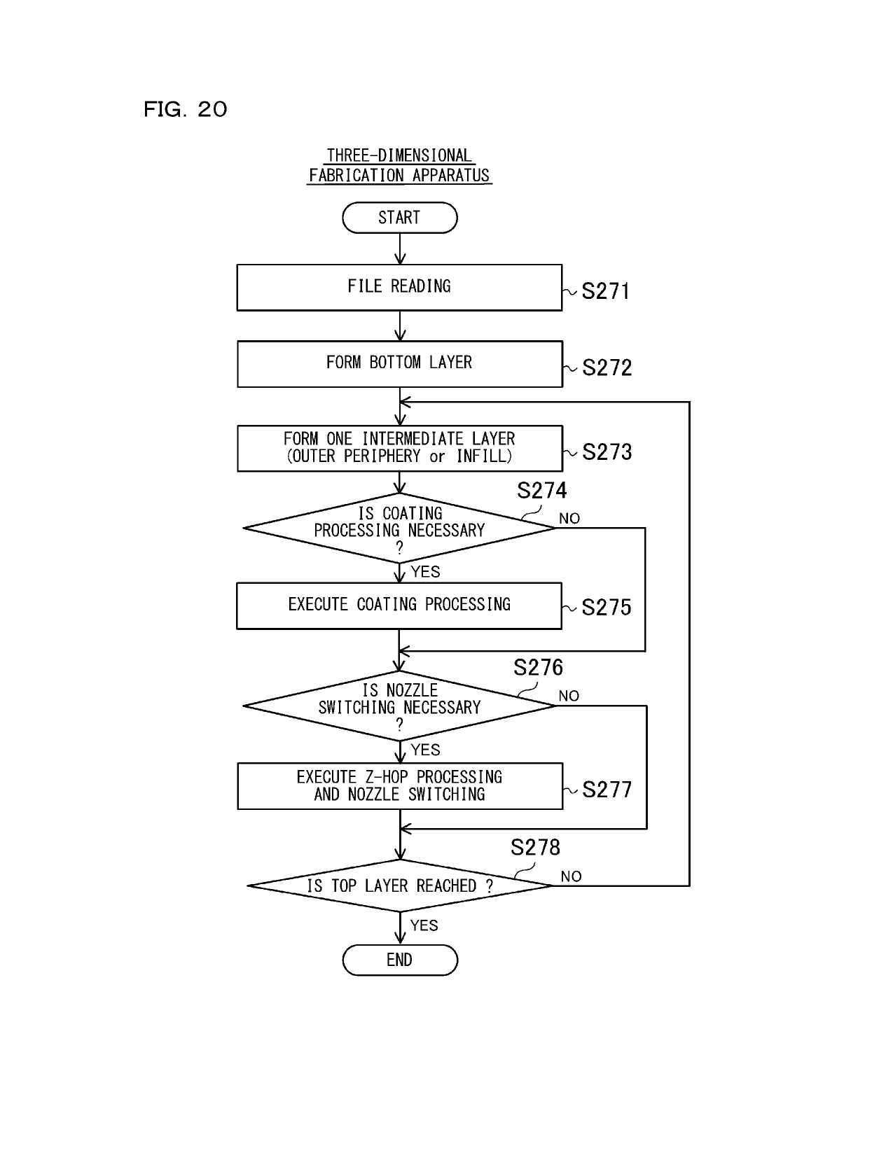

Here, FIG. 20 is a flowchart illustrating a fabrication procedure in the speed fabrication mode M21. First, in step S271 of FIG. 20, the control section 9 acquires the fabrication data D1 collated with the configuration information Di.

In subsequent step S272, the control section 9 controls the first head unit 3A to which the first nozzle outlet 323a having a small diameter is fixed so that a bottom layer (not illustrated) of the three-dimensional fabrication object Ob is fabricated. The control section 9 ejects the first filament F1 from the first nozzle outlet 323a while moving the first hot end 32A along a trajectory corresponding to the bottom layer.

In subsequent step S273, the control section 9 controls the first or second hot end 32A, 32B so that one intermediate layer in the three-dimensional fabrication object Ob is formed. Here, one intermediate layer indicates an outer peripheral portion or an infill layer excluding the bottom layer and the top layer.

In step S273, the control section 9 selectively operates the first hot end 32A and the second hot end 32B according to the path Pa illustrated in (c) of FIG. 18. At this time, one of the first hot end 32A and the second hot end 32B is disposed at the fabrication position described with reference to FIG. 14A, and the other of the first hot end 32A and the second hot end 32B is retracted to the retraction position described with reference to FIG. 14A.

In step S273, a surface portion of the three-dimensional fabrication object Ob is fabricated by the first filament F1 ejected from the first hot end 32A, and an infill (inner portion) of the three-dimensional fabrication object Ob is fabricated by the second filament F2 ejected from the second hot end 32B.

That is, in step S274, the control section 9 as the control part alternatively executes the stacking of the first filament layer L1 constituted by the fused first filament F1 ejected from the first hot end 32A and the stacking of the second filament layer L2 constituted by the fused second filament F2 ejected from the second hot end 32B.

When one intermediate layer is formed, the control section 9 advances the control process to step S274. In step S274, the control section 9 determines the necessity of the coating processing. This determination can be executed on the basis of the necessity flag stored in the storage section 8. This necessity flag can be set in advance by a user input. The necessity flag is YES in a case where the hot end 32 is switched, and is NO in a case where the hot end is not switched.

For example, the necessity flag is YES when the formation of the intermediate layer for two layers by the first hot end 32A or the formation of the intermediate layer for one layer by the second hot end 32B is completed, and is NO when the formation of the intermediate layer for one layer by the first hot end 32A is completed.

In a case where the determination in step S274 is NO, the control section 9 advances the control process to step S275. On the other hand, in a case where the determination in step S274 is YES, the control section 9 advances the control process to step S275.

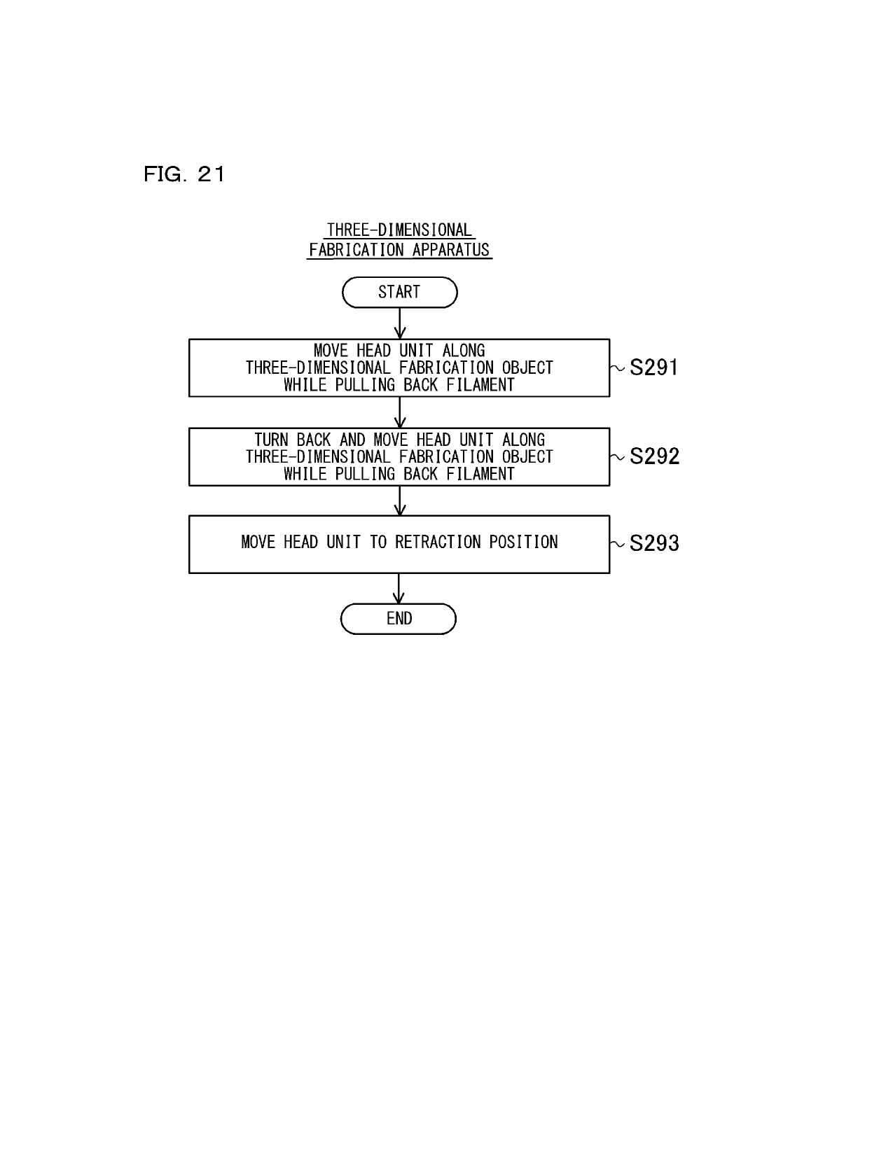

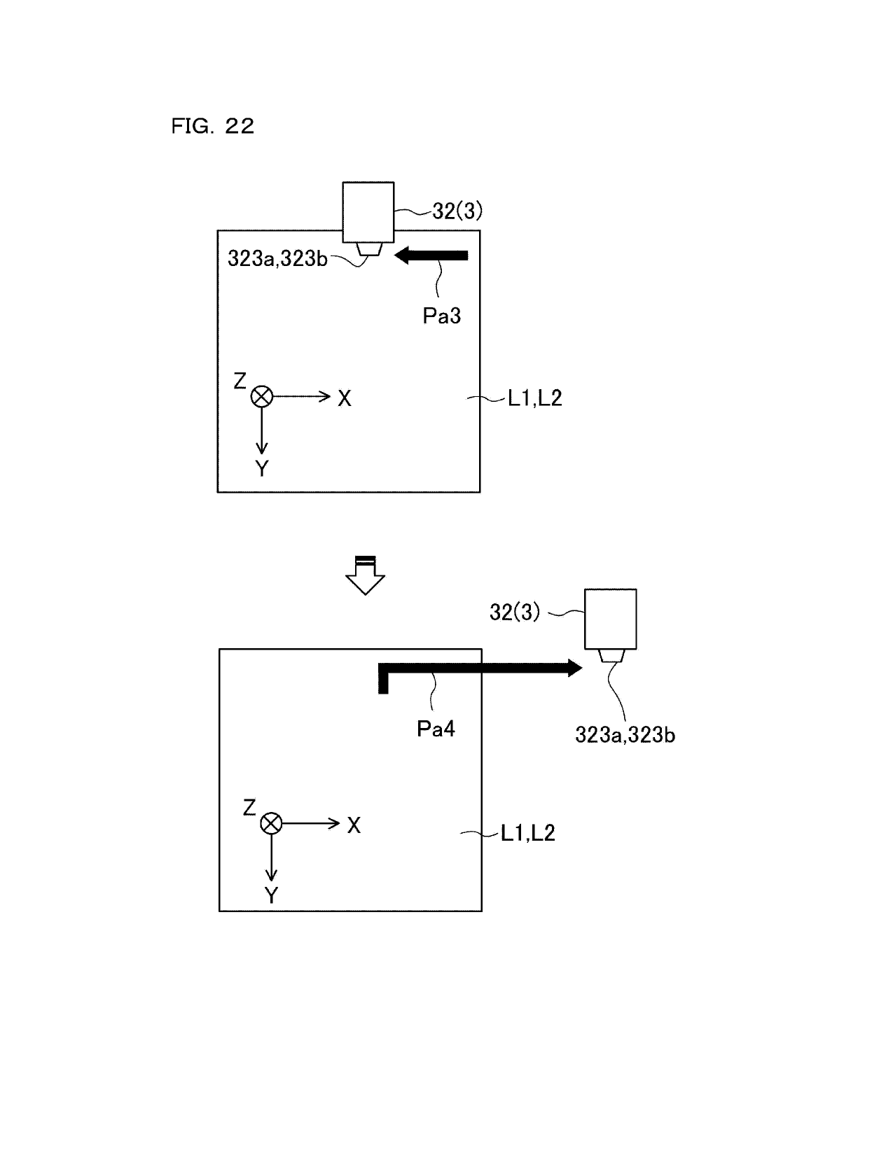

In step S275, the control section 9 executes the coating processing. For the coating processing, refer to FIGS. 21 and 22. The coating processing is processing performed after either the first or second filament layer L1 or L2 is stacked.

FIG. 21 is a flowchart exemplifying the coating processing, and FIG. 22 is a diagram for describing a trajectory of the head unit 3 in the coating processing. FIG. 21 illustrates processing performed in step S275 of FIG. 20.

First, in step S291 of FIG. 21, the control section 9 operates the head unit 3 to which one extruder 31 used for stacking the first or second filament layers L1 and L2 among the extruders 31 and 31 of the first and second head units 3A and 3B is fixed so as to move along the first or second filament layers L1 and L2 (see the trajectory Pa3 of FIG. 22). As illustrated in the upper part of FIG. 22, this movement is performed along the XY plane.

Specifically, in the processing of step S291, the control section 9 moves one head unit 3 or the hot end 32 fixed to the head unit 3 along the upper surface of the three-dimensional fabrication object Ob being fabricated.

Then, the control section 9 executes the movement of the head unit 3 along the first or second filament layer L1 or L2 while pulling back the filament Fi by one extruder 31.

In other words, the control section 9 moves the head unit 3 to which the hot end 32 is fixed along the three-dimensional fabrication object Ob while pulling back the filament Fi leaking from the distal end of the hot end 32 by the extruder 31. By moving in this manner, the filament Fi leaking from a distal end of the hot end 32 is applied to the upper surface of the three-dimensional fabrication object Ob being fabricated.

In the subsequent step, the control section 9 controls one head unit 3 so that the head unit 3 reaches a predetermined retraction position (see FIG. 14A) after being turned back and moved along the first or second filament layer L1 or L2 (see a trajectory Pa4 in FIG. 22). As illustrated in the lower part of FIG. 22, this movement is performed along the XY plane.

Specifically, in the process of step S292, the control section 9 causes one head unit 3 or the hot end 32 fixed to the head unit 3 to be turned back and moved along the upper surface of the three-dimensional fabrication object Ob being fabricated.

More specifically, the control section 9 executes the return movement of the head unit 3 along the first or second filament layer L1 or L2 while pulling back the filament Fi by one extruder 31.

When one head unit 3 reaches the retraction position, the control section 9 ends the coating processing (step S293). Thereafter, the control section 9 starts new stacking of the first or second filament layers L1 and L2 through determination in step S278 described later.

Returning to the flow of FIG. 20, in step S276 following step S274 or step S275, the control section 9 determines whether or not switching of the nozzle 323 is necessary (whether or not switching of the head unit 3 or the hot end 32 is necessary) on the basis of the fabrication data D1. As will be described later, the control section 9 according to the present embodiment controls the first head unit 3A or the second head unit 3B on the basis of the determination result on the necessity of switching.

Specifically, in the case of the speed fabrication mode M21, the determination in step S276 is YES when the formation of the intermediate layer for two layers by the first hot end 32A or the formation of the intermediate layer for one layer by the second hot end 32B is completed, and is NO when the formation of the intermediate layer for one layer by the first hot end 32A is completed.

In a case where the determination in step S276 is NO, the control section 9 advances the control process to step S278. In a case where the determination in step S276 is YES, the control section 9 advances the control process to step S277.

In step S277, the control section 9 executes the Z-hop processing and nozzle switching. The details of these processing are as illustrated in FIG. 14A referenced with respect to the description of Z-hop. In step S277, the control section 9 sequentially executes the operations of (a) to (d) in FIG. 14A.

In subsequent step S278, the control section 9 determines whether or not the top layer of the three-dimensional fabrication object Ob has been reached. This determination can be executed on the basis of the information included in the fabrication data D1.

In a case where the determination in step S278 is NO, the control section 9 returns the control process to step S273. In a case where the determination in step S278 is YES, the control section 9 ends the flow of FIG. 20.

That is, the control section 9 repeatedly executes the processing from step S273 to step S277 until the determination in step S278 becomes YES. When the process of step S273 is repeatedly executed, the fused first filament F1 is ejected at each Z position arranged in the Z direction, and the fused second filament F2 is ejected at every other Z position or every two Z positions (see (d) of FIG. 18).

By ejecting in this manner, as illustrated in FIGS. 2 and 9B, the first filament layer L1 is formed at a fine stacking pitch in the outer peripheral portion, and the second filament layer L2 is formed at a coarse stacking pitch in the infill.

### 8. Significance of speed fabrication mode M21

As illustrated in FIGS. 2 and 9B, and the like, the first nozzle outlet 323a from which the resin for fabricating the surface portion is ejected has a smaller diameter than the second nozzle outlet 323b from which the resin for fabricating the inner portion is ejected. In this way, the inner portion is fabricated at a coarser stacking pitch than an outer peripheral portion, and thus, the fabrication speed is excellent. On the other hand, since the surface portion is fabricated at a finer stacking pitch than the inner portion, the surface portion is excellent in aesthetics. Therefore, both the aesthetics and the fabrication time of the three-dimensional fabrication object can be achieved by performing the fabrication in which the two nozzle outlets 323a and 323b are combined.

Furthermore, as illustrated in FIG. 10, the user can freely set the necessity of the speed fabrication mode. This can improve user convenience.

Furthermore, as in the support addition mode M22 illustrated in FIG. 9B, the three-dimensional fabrication apparatus A1 can provide a fabrication mode Mp using both the first hot end 32A and the second hot end 32B in addition to the speed fabrication mode M21. Since the number of options of the user increases, user convenience can be improved.

Furthermore, by performing the coating processing illustrated in FIGS. 21 and 22, the resin leaking from the nozzle outlets 323a and 323b after the first or second filament layers L1 and L2 are stacked can be applied to the first or second filament layers L1 and L2 immediately after the stacking without accumulating the resin at a specific location. Thus, the aesthetics of the three-dimensional fabrication object Ob can be enhanced.

Furthermore, as described with reference to FIG. 22 and the like, by moving the first or second hot ends 32A and 32B while pulling back the first or second filaments F1 and F2, it is possible to more reliably apply the resin to the first or second filament layers L1 and L2 immediately after stacking. Thus, the aesthetics of the three-dimensional fabrication object Ob can be enhanced.

### 9. Other embodiments

In the above embodiment, the surface portion (outer peripheral portion) of the three-dimensional fabrication object Ob is fabricated by the first hot end 32A as the first nozzle member, and the inner portion (infill) of the three-dimensional fabrication object Ob is fabricated by the second hot end 32B as the second nozzle member. However, the roles assigned to the first hot end 32A and the second hot end 32B may be changed by causing the processing part 105 to function as the allocation change section.

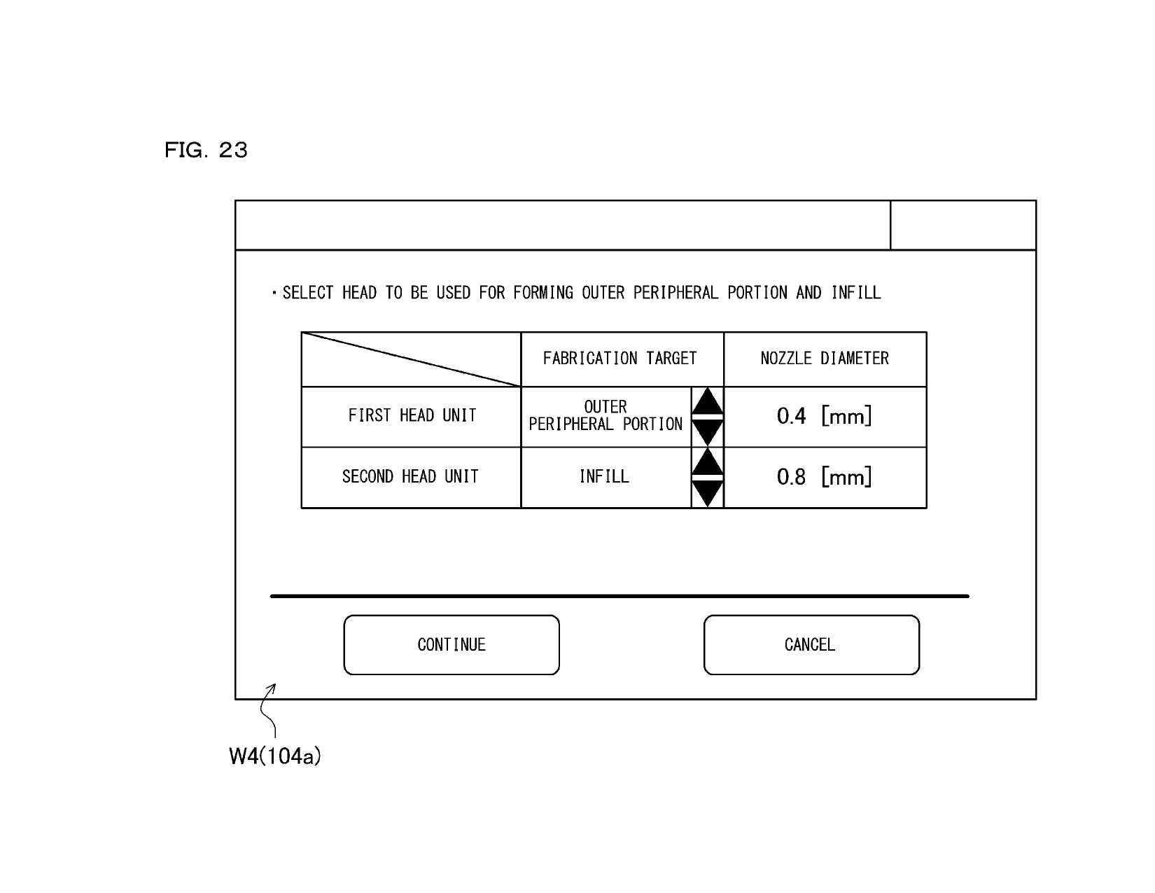

FIG. 23 is a diagram illustrating an allocation change section. For example, when the speed fabrication mode M21 is selected via the first window W1 of FIG. 10, the processing part 105 can display an allocation change screen W4 illustrated in FIG. 23. The allocation change screen W4 includes a GUI capable of receiving an operation input by the user. The processing part 105 can receive, via the GUI, selection of whether to fabricate the outer peripheral portion or fabricate the infill with the first head unit 3A, more specifically, the first hot end 32A, and selection of whether to fabricate the outer peripheral portion or fabricate the infill with the second head unit 3B, more specifically, the second hot end 32B.

With this configuration, the user can change the assignment of the fabrication data D1 to each of the first hot end 32A and the second hot end 32B. This can improve user convenience.

What is claimed is:

1. A three-dimensional fabrication apparatus configured to fabricate a three-dimensional fabrication object by extruding a fused filament to a fabrication plate that lowers in stages, the three-dimensional fabrication apparatus comprising:
a supply part configured to supply the filament before being fused;
a first extrusion part configured to draw in the filament supplied from the supply part and extrudes the filament downward;
a first nozzle member configured to fuse the filament extruded by the first extrusion part and eject the fused filament to the fabrication plate;
a first head unit to which the first extrusion part and the first nozzle member are fixed and configured to be movable along a direction in which the fabrication plate spreads;
a second extrusion part configured to draw in the filament supplied from the supply part and extrude the filament downward;
a second nozzle member configured to fuse the filament extruded by the second extrusion part and eject the fused filament to the fabrication plate, the second nozzle member including a nozzle outlet having a larger diameter than a nozzle outlet of the first nozzle member;
a second head unit to which the second extrusion part and the second nozzle member are fixed and configured to be movable along the direction in which the fabrication plate spreads;
a storage part configured to store fabrication data for fabricating the three-dimensional fabrication object, the fabrication data including a trajectory assigned to each of the first nozzle member and the second nozzle member; and
a control part configured to, on a basis of the fabrication data stored in the storage part, control the first head unit so that a surface portion of the three-dimensional fabrication object is fabricated by the fused filament ejected from the first nozzle member, and control the second head unit so that an inner portion of the three-dimensional fabrication object is fabricated by the fused filament ejected from the second nozzle member.

2. A three-dimensional fabrication system including the three-dimensional fabrication apparatus according to claim 1, the three-dimensional fabrication system comprising:
a mode selection section configured to select any one fabrication mode from among a speed fabrication mode in which the first head unit and the second head unit are controlled such that the surface portion of the three-dimensional fabrication object is fabricated by the fused filament ejected from the first nozzle member and the inner portion of the three-dimensional fabrication object is fabricated by the fused filament ejected from the second nozzle member, and one or a plurality of other fabrication modes in which operations of the first nozzle member and the second nozzle member are made different from operations in the speed fabrication mode;
a fabrication data creation section configured to create the fabrication data on a basis of the fabrication mode selected by the mode selection section; and
an output section configured to output the fabrication data to the three-dimensional fabrication apparatus so as to operate the first nozzle member and the second nozzle member in accordance with the fabrication data created by the fabrication data creation section.

3. The three-dimensional fabrication system according to claim 2, further comprising an allocation change section configured to change allocation of the fabrication data to each of the first nozzle member and the second nozzle member on a basis of a user input.

4. The three-dimensional fabrication system according to claim 2, wherein
the one or the plurality of other fabrication modes includes a support addition mode in which the first head unit and the second head unit are controlled such that a model portion of the three-dimensional fabrication object is fabricated by the fused filament ejected from one of the first nozzle member and the second nozzle member, and a support portion of the three-dimensional fabrication object is fabricated by another fused filament ejected from another of the first nozzle member and the second nozzle member.

5. The three-dimensional fabrication apparatus according to claim 1, wherein
the control part selectively executes stacking of a first filament layer including the fused filament ejected from the first nozzle member and stacking of a second filament layer including the fused filament ejected from the second nozzle member, and
after the first filament layer or the second filament layer is stacked, the control part
operates one head unit to which one extrusion part used for the stacking of the first filament layer or the second filament layer among the first extrusion part and the second extrusion part is fixed so as to move along the first filament layer or the second filament layer,
operates the one head unit so as to reach a predetermined retraction position after the one head unit is turned back and moved along the first filament layer or the second filament layer, and
starts new stacking of the first filament layer or the second filament layer after the one head unit reaches the retraction position.

6. The three-dimensional fabrication apparatus according to claim 5, wherein
the first extrusion part and the second extrusion part are operable to pull in and pull back the filament upward, and
the control part executes movement of the one head unit along the first filament layer or the second filament layer and return movement of the one head unit along the first filament layer or the second filament layer while pulling back the filament by the one extrusion part.

7. The three-dimensional fabrication apparatus according to claim 1, wherein
the first extrusion part pulls in and extrudes downward the first filament supplied from the supply part, and
the second extrusion part pulls in and extrudes downward the second filament supplied from the supply part and different from the first filament.

8. The three-dimensional fabrication apparatus according to claim 1, wherein
the first extrusion part and the second extrusion part each include a gear configured to mesh with the filament, and a motor configured to rotate the gear.

9. The three-dimensional fabrication apparatus according to claim 1, wherein
the fabrication data stored in the storage part includes, in a plurality of layers in which an object corresponding to three-dimensional data of the three-dimensional fabrication object is sliced in a Z direction, a first path corresponding to the surface portion of the three-dimensional fabrication object and a second path corresponding to the inner portion of the three-dimensional fabrication object, and
the control part controls the first head unit on a basis of the first path and controls the second head unit on a basis of the second path.

10. The three-dimensional fabrication apparatus according to claim 8, wherein
the control part makes a determination on whether or not switching between the first nozzle member and the second nozzle member is necessary on a basis of fabrication data stored in the storage part during the fabrication of the three-dimensional fabrication object, and controls the first head unit or the second head unit on a basis of a result of the determination.

11. The three-dimensional fabrication apparatus according to claim 10, wherein
the control part executes Z-hop processing of temporarily lowering the fabrication plate in a Z direction when switching from fabrication by one of the first head unit and the second head unit to fabrication by another on a basis of the result of the determination.
